(19) United States
(12) Patent Application Publication
(10) Pub. No.: US 2018/0161726 A1
(43) Pub. Date: Jun. 14, 2018

(54) SYSTEM AND METHOD FOR MERCURY CONTROL FOR USE IN CONJUNCTION WITH ONE OR MORE NATIVE HALOGENS CONTAINED IN A COMBUSTION FUEL AND/OR SOURCE

(71) Applicant: The Babcock & Wilcox Company, Barberton, OH (US)

(72) Inventors: Mandar R. GADGIL, Akron, OH (US); Prasanna SESHADRI, Akron, OH (US)

(21) Appl. No.: 15/375,937

(22) Filed: Dec. 12, 2016

(51) Int. Cl. B01D 53/86; F23J 15/02

(52) U.S. Cl. CPC B01D 53/8659; B01D 53/8628; F23J 15/02; B01D 2257/202; B01D 2257/204; B01D 2255/20738; F23J 2219/10; B01D 2255/20753; B01D 2255/20746; B01D 2257/602; B01D 2258/0283; F23J 2215/30; B01D 2255/20761

(57) ABSTRACT

The present invention relates generally to the field of emission control equipment for boilers, heaters, kilns, or other flue gas-, or combustion gas-, generating devices (e.g., those located at power plants, processing plants, etc.) and, in particular to a new and useful method and apparatus for: (a) achieving a reduction in the level of one or more halogens, or halogen-containing compounds, necessary to affect gas-phase mercury control; (b) permitting the oxidation of at least a portion of any elemental mercury (Hg⁰) contained in a flue gas and/or combustion gas stream; and/or (c) permitting the oxidation of at least a portion of any elemental mercury (Hg⁰) contained in a flue gas and/or combustion gas stream so that the use of at least one post-oxidation mercury capture method and/or process results in the capture of at least a portion of oxidized mercury contained in the flue gas and/or combustion gas stream.

### FIELD AND BACKGROUND OF THE INVENTION

### 1. Field of the Invention

The present invention relates generally to the field of emission control equipment for boilers, heaters, kilns, or other flue gas-, or combustion gas-, generating devices (e.g., those located at power plants, processing plants, etc.) and, in particular to a new and useful method and apparatus for: (i) reducing mercury levels in one or more flue gas and/or combustion gas streams using a combination of one or more halogens, or halogen-containing compounds, present in a combustible fuel and/or combustible material in conjunction with one or more metal-bearing compounds and up to about 25 ppm of one or more additionally supplied halogens, or additionally supplied halogen-containing compounds, in order to affect gas-phase mercury control; (ii) reducing mercury levels in one or more flue gas and/or combustion gas streams using a combination of one or more halogens, or halogen-containing compounds, present in a combustible fuel and/or combustible material in conjunction with one or more metal-bearing compounds and up to about 10 ppm of one or more additionally supplied halogens, or additionally supplied halogen-containing compounds, in order to affect gas-phase mercury control; and/or (iii) reducing mercury levels in one or more flue gas and/or combustion gas streams using a combination of one or more halogens, or halogen-containing compounds, present in a combustible fuel and/or combustible material in conjunction with one or more metal-bearing compounds where the need for any amount of additionally supplied halogens, or additionally supplied halogen-containing compounds, has been eliminated in order to affect gas-phase mercury control. In another embodiment, the method and apparatus of the present invention is designed to: (a) achieve a reduction in the level of one or more halogens, or halogen-containing compounds, necessary to affect gas-phase mercury control; (b) permit the oxidation of at least a portion of any elemental mercury (Hg⁰) contained in a flue gas and/or combustion gas stream; and/or (c) permit the oxidation of at least a portion of any elemental mercury (Hg⁰) contained in a flue gas and/or combustion gas stream so that the use of at least one post-oxidation mercury capture method and/or process results in the capture of at least a portion of oxidized mercury contained in the flue gas and/or combustion gas stream.

### 2. Description of the Related Art

NOₓ refers to the cumulative emissions of nitric oxide (NO), nitrogen dioxide (NO₂) and trace quantities of other nitrogen oxide species generated during combustion. Combustion of any fossil fuel generates some level of NOₓ due to high temperatures and the availability of oxygen and nitrogen from both the air and fuel. NOₓ emissions may be controlled using low NOₓ combustion technology and post-combustion techniques. One such post-combustion technique involves selective catalytic reduction (SCR) systems in which a catalyst facilitates a chemical reaction between NOₓ and a reagent (usually ammonia) to produce molecular nitrogen and water vapor.

SCR technology is used worldwide to control NOₓ emissions from combustion sources. This technology has been used widely in Japan for NOₓ control from utility boilers since the late 1970's, in Germany since the late 1980's, and in the US since the 1990's. Industrial scale SCRs have been designed to operate principally in the temperature range of 500° F. to 900° F., but most often in the range of 550° F. to 750° F. SCRs are typically designed to meet a specified NOₓ reduction efficiency at a maximum allowable ammonia slip. Ammonia slip is the concentration, expressed in parts per million by volume, of unreacted ammonia exiting the SCR.

For additional details concerning NOₓ removal technologies used in the industrial and power generation industries, the reader is referred to Steam/its generation and use, 41^{st} Edition, Kitto and Stultz, Eds., Copyright 2005, The Babcock & Wilcox Company, Barberton, Ohio, U.S.A., particularly Chapter 34—Nitrogen Oxides Control, the complete text of which is hereby incorporated by reference as though fully set forth herein.

Regulations issued by the EPA promise to increase the portion of utility boilers equipped with SCRs. SCRs are generally designed for a maximum efficiency of about 90 percent. This limit is not set by any theoretical limits on the capability of SCRs to achieve higher levels of NOₓ destruction. Rather, it is a practical limit set to prevent excessive levels of ammonia slip. This problem is explained as follows.

In an SCR, ammonia reacts with NOₓ according to one or more of the following stoichiometric reactions (a) to (d):

4NO+4NH₃+O₂→4N₂+6H₂O (a)

12NO₂+12NH₃→12N₂+18H₂O+3O₂ (b)

2NO₂+4NH₃+O₂→3N₂+6H₂O (c)

NO+NO₂+2NH₃→2N₂+3H₂O (d).

The above catalysis reactions occur using a suitable catalyst. Suitable catalysts are discussed in, for example, U.S. Pat. Nos. 5,540,897; 5,567,394; and U.S. Pat. No. 5,585,081 to Chu et al., all of which are hereby incorporated by reference as though fully set forth herein. Catalyst formulations generally fall into one of three categories: base metal, zeolite and precious metal.

Base metal catalysts use titanium oxide with small amounts of vanadium, molybdenum, tungsten or a combination of several other active chemical agents. The base metal catalysts are selective and operate in the specified temperature range. The major drawback of the base metal catalyst is its potential to oxidize SO₂ to SO₃; the degree of oxidation varies based on catalyst chemical formulation. The quantities of SO₃ which are formed can react with the ammonia carryover to form various ammonium-sulfate salts.

Zeolite catalysts are aluminosilicate materials which function similarly to base metal catalysts. One potential advantage of zeolite catalysts is their higher operating temperature of about 970° F. (521° C.). These catalysts can also oxidize SO₂ to SO₃ and must be carefully matched to the flue gas conditions.

Precious metal catalysts are generally manufactured from platinum and rhodium. Precious metal catalysts also require careful consideration of flue gas constituents and operating temperatures. While effective in reducing NOₓ, these catalysts can also act as oxidizing catalysts, converting CO to CO₂ under proper temperature conditions. However, SO₂ oxidation to SO₃ and high material costs often make precious metal catalysts less attractive.

As is known to those of skill in the art, various SCR catalysts undergo poisoning when they become contaminated by various compounds including, but not limited to, certain phosphorus compounds such as phosphorus oxide (PO) or phosphorus pentoxide (P₂O₅). Additionally, it is also well known that SCR catalysts degrade over time and have to be replaced periodically at a significant cost and loss of generating capacity. In a typical 100 MWe coal plant the downtime and cost associated with the replacement of underperforming catalyst can be in the neighborhood of one million US dollars or more.

More particularly, as the SCR catalysts are exposed to the dust laden flue gas there are numerous mechanisms including blinding, masking and poisoning that deactivates the catalyst and causes a decrease in the catalyst's performance over time. The most common catalyst poison encountered when burning eastern domestic coal (i.e., coal mined in the eastern United States) is arsenic. The most common catalyst poison encountered when burning western domestic coal (i.e., coal mined in the western United States) is phosphorus and calcium sulfate is the most common masking mechanism. One method of recycling the used catalyst is the process called regeneration washing or rejuvenation. The initial steps of the regeneration process involve the removal of these toxic chemicals by processing the catalysts through various chemical baths in which the poisons are soluble. While this treatment process does an excellent job of removing the desired poisons it produces wastewater with very high arsenic concentrations.

In another situation, Powder River Basin coal plants, lignite coal plants, or any type of coal plant that utilizes one or more types of coals to produce steam or some other combustion product, any coal/biomass co-combustion, or any coal/bone meal co-combustion or even pure biomass combustion power plants will suffer from phosphorus contamination of their SCR catalysts. Furthermore, other types of fossil fuel-fired combustion processes can generate phosphorus levels that lead to undesirable levels of phosphorus contamination of an SCR catalyst. For example, fuel oil combustion processes can, in some instances, suffer from phosphorus levels that lead to undesirable levels of phosphorus contamination of an SCR catalyst.

Additionally, beyond controlling NOₓ emissions, other emission controls must be considered and/or met in order to comply with various state, EPA and/or Clean Air Act regulations. Some other emission controls which need to be considered for boilers, heaters, kilns, or other flue gas-, or combustion gas-, generating devices (e.g., those located at power plants, processing plants, etc.) include, but are not limited to, mercury, SOₓ, and certain particulates.

Furthermore, in most situations, if not all, it is desirable to remove various SOₓ compounds by way of either one or more wet flue gas desulfurization (WFGD) units or one or more dry flue gas desulfurization (DFGD) units from a flue gas. As is known to those of skill in the art, in conjunction with SOₓ removal it is common (and now required in most instances) to also remove and/or reduce the amount of mercury in a flue gas. One suitable method of mercury control is mercury oxidation and capture via the use of one or more halogen compounds to accomplish the aforesaid mercury oxidation and the subsequently capturing the oxidized mercury compound (e.g., in the form of a mercuric halide). It has been found that when mercury control is accomplished in whole, or in part, through the use of one or more halogen compounds (e.g., halide salts such as calcium bromide, etc.) that such compounds negatively impact on the selenium speciation in the flue gas which in turn negatively impacts the amount of selenium that is emitted via the liquid effluent outflow from one or more WFGD units, and or the particulate matter produced by one or more DFGD units that are utilized to control SOₓ in the same flue gas stream. However, it should be noted that the present invention is not limited to just the aforementioned situation. In fact, in one embodiment the present invention relates to a method and apparatus for controlling, mitigating and/or reducing the amount of selenium contained in and/or emitted by one or more pieces of emission control equipment for boilers, heaters, kilns, or other flue gas-, or combustion gas-, generating devices (e.g., those located at power plants, processing plants, etc.). In another embodiment, the present invention relates to method and apparatus for controlling the selenium speciation in one, or both, of a gas phase or a aqueous phase by the addition of at least one metal additive at any point upstream (as will be detailed below) of either a wet flue gas desulfurization (WFGD) unit and/or a dry flue gas desulfurization (DFGD) unit. In still another embodiment, present invention offers a method and apparatus by which to simultaneously control at least selenium speciation in one, or both, of a gas phase or an aqueous phase while further controlling at least one of gas phase phosphorus, gas phase sodium, gas phase potassium, and/or mercury in at least one emission from a combustion process.

In, for example, a coal combustion process the addition of one or more halogens, or halogen-containing compounds, (e.g., calcium chloride, calcium bromide, calcium iodide, or any other suitable halogen-containing compound) forms one or more corresponding gaseous hydrogen halide compounds (e.g., HF, HCl, HBr and/or HI). Hydrogen halide gases including, but not limited to, HF, HCl, HBr and/or HI gases are not very reactive towards mercury and cause both high temperature corrosion under reducing atmosphere in a furnace and low temperature corrosion at an air heater outlet. For example, HF, HCl, HBr and HI are respectively converted to Br and Br₂, Cl and Cl₂, I and I₂ gases by the Deacon reactions shown below:

4HF(g)+O₂(g)→2H₂O(g)+2F₂(g)

4HCl(g)+O₂(g)→2H₂O(g)+2Cl₂(g)

4HBr(g)+O₂(g)→2H₂O(g)+2Br₂(g)

4HI(g)+O₂(g)→2H₂O(g)+2I₂(g).

F₂, Cl₂, Br₂, I₂ or another elemental form of a different halogen, in the gas phase then reacts with Hg in the gas phase to produce one or more mercuric halides (e.g., HgF2, HgCl₂, HgBr₂, HgI₂, etc.) in the gas phase. The one or more mercuric halide compounds in this example contain the oxidized mercury. These one or more halide forms of mercury are easily removed using flue gas desulfurization (FGD) equipment and/or through the use of one or more mercury capture technologies including, but not limited to, the injection of one or more activated carbon and/or halogenated activated carbons, the use and/or injection of one or more sulfur-containing and/or sulfide-containing capture compounds, etc. Additionally, other coal-based process such as the production of syngas from coal produce undesirable levels of phosphorus compounds thereby resulting in the undesirable deactivation of one or more catalysts associated with such production processes.

In addition to the above reaction, another reaction takes place in the combustion gas and/or flue gas stream in the presence of sulfur dioxide (SO₂) and water called the Griffin reaction. The various Griffin reactions for fluorine, chlorine, bromine and iodine are detailed below:

SO₂(g)+F₂(g)+H₂O(g)→SO₃(g)+2HF(g)

SO₂(g)+Cl₂(g)+H₂O(g)→SO₃(g)+2HCl(g)

SO₂(g)+Br₂(g)+H₂O(g)→SO₃(g)+2HBr(g)

SO₂(g)+I₂(g)+H₂O(g)→SO₃(g)+2HI(g).

As can be seen from the reactions above, when the Griffin reaction thermodynamics are favored, the above one or more reactions serve to reduce the amount of diatomic halogen present in a combustion gas and/or flue gas and therefore result in a reduction in the amount of diatomic halogen available to convert and/or oxidize elemental mercury (Hg⁰) into one or more mercury halides. As is known to those of skill in the art, the presence of one or more mercury halides substantially increases the ability of later mercury capture technologies (e.g., the use of one or more inorganic sulfide compounds and/or organic sulfide compounds) to capture the oxidized mercury present in the flue gas stream or in some downstream air quality control system. As such, the backbiting caused by the above detailed Griffin reaction, or reactions, makes the amount of mercury captured decrease. Accordingly, it makes it harder and/or more expensive to meet mercury compliance regulations such as MATS.

Given the above, a need exists for a method that provides for any economical and environmentally suitable method and/or system that: (i) permits a reduction in the level of one or more halogens, or halogen-containing compounds, necessary to affect gas-phase mercury control; (ii) permits the oxidation of at least a portion of any elemental mercury (Hg⁰) contained in a flue gas and/or combustion gas stream; and/or (iii) permits the oxidation of at least a portion of any elemental mercury (Hg⁰) contained in a flue gas and/or combustion gas stream so that the use of at least one post-oxidation mercury capture method and/or process results in the capture of at least a portion of oxidized mercury contained in the flue gas and/or combustion gas stream.

### SUMMARY OF THE INVENTION

The present invention relates generally to the field of emission control equipment for boilers, heaters, kilns, or other flue gas-, or combustion gas-, generating devices (e.g., those located at power plants, processing plants, etc.) and, in particular to a new and useful method and apparatus for: (i) reducing mercury levels in one or more flue gas and/or combustion gas streams using a combination of one or more halogens, or halogen-containing compounds, present in a combustible fuel and/or combustible material in conjunction with one or more metal-bearing compounds and up to about 25 ppm of one or more additionally supplied halogens, or additionally supplied halogen-containing compounds, in order to affect gas-phase mercury control; (ii) reducing mercury levels in one or more flue gas and/or combustion gas streams using a combination of one or more halogens, or halogen-containing compounds, present in a combustible fuel and/or combustible material in conjunction with one or more metal-bearing compounds and up to about 10 ppm of one or more additionally supplied halogens, or additionally supplied halogen-containing compounds, in order to affect gas-phase mercury control; and/or (iii) reducing mercury levels in one or more flue gas and/or combustion gas streams using a combination of one or more halogens, or halogen-containing compounds, present in a combustible fuel and/or combustible material in conjunction with one or more metal-bearing compounds where the need for any amount of additionally supplied halogens, or additionally supplied halogen-containing compounds, has been eliminated in order to affect gas-phase mercury control. In another embodiment, the method and apparatus of the present invention is designed to: (a) achieve a reduction in the level of one or more halogens, or halogen-containing compounds, necessary to affect gas-phase mercury control; (b) permit the oxidation of at least a portion of any elemental mercury (Hg⁰) contained in a flue gas and/or combustion gas stream; and/or (c) permit the oxidation of at least a portion of any elemental mercury (Hg⁰) contained in a flue gas and/or combustion gas stream so that the use of at least one post-oxidation mercury capture method and/or process results in the capture of at least a portion of oxidized mercury contained in the flue gas and/or combustion gas stream.

Accordingly, one aspect of the present invention is drawn to a method for reducing or eliminating the amount and/or concentration of one or more halogen-containing compounds used to achieve mercury capture in a flue gas, the method comprising the steps of: (a) providing at least one combustible fuel source to a combustion zone of a furnace or boiler, the at least one combustible fuel having a sufficient level of one or more native halogens and/or native halogen-containing compounds; (b) providing one or more metal-bearing compounds to a combustion zone or flue gas stream of a furnace, or boiler, at a point that is both prior to entry of the flue gas into an SCR; (c) providing less than about 50 ppm of one or more halogen-containing compounds to a combustion zone or flue gas stream of a furnace, or boiler, prior to entry of the flue gas into an SCR, wherein the halogen portion of the one or more halogen-containing compounds are liberated in the combustion zone or flue gas stream of the furnace or boiler and are converted to one or more corresponding gaseous hydrogen halide compounds; (d) permitting the one or more metal-bearing compounds to catalyze the conversion of the corresponding one or more hydrogen halides formed from the injection of the one or more halogen-containing compounds and any one or more hydrogen halides formed from any one or more native halogen compounds and/or one or more native halogen-containing compounds to one or more corresponding elemental halogen compounds; and (e) permitting the resulting one or more corresponding elemental halogen compounds to react with gaseous mercury present in the combustion zone or flue gas stream of the furnace, or boiler, thereby resulting in oxidation of the gaseous mercury so as to convert the gaseous mercury into one or more corresponding mercury halides.

In yet another aspect of the present invention, there is provided a method for reducing or eliminating the amount and/or concentration of one or more halogen-containing compounds used to achieve mercury capture in a flue gas, the method comprising the steps of: (A) providing at least one combustible fuel source to a combustion zone of a furnace or boiler, the at least one combustible fuel having a sufficient level of one or more native halogens and/or native halogen-containing compounds; (B) providing one or more metal-bearing compounds to a combustion zone or flue gas stream of a furnace, or boiler, at a point that is both prior to entry of the flue gas into an SCR; (C) providing less than about 25 ppm of one or more halogen-containing compounds to a combustion zone or flue gas stream of a furnace, or boiler, prior to entry of the flue gas into an SCR, wherein the halogen portion of the one or more halogen-containing compounds are liberated in the combustion zone or flue gas stream of the furnace or boiler and are converted to one or more corresponding gaseous hydrogen halide compounds; (D) permitting the one or more metal-bearing compounds to catalyze the conversion of the corresponding one or more hydrogen halides formed from the injection of the one or more halogen-containing compounds and any one or more hydrogen halides formed from any one or more native halogen compounds and/or one or more native halogen-containing compounds to one or more corresponding elemental halogen compounds; and (E) permitting the resulting one or more corresponding elemental halogen compounds to react with gaseous mercury present in the combustion zone or flue gas stream of the furnace, or boiler, thereby resulting in oxidation of the gaseous mercury so as to convert the gaseous mercury into one or more corresponding mercury halides.

In yet another aspect of the present invention, there is provided a method for reducing or eliminating the amount and/or concentration of one or more halogen-containing compounds used to achieve mercury capture in a flue gas, the method comprising the steps of: (I) providing at least one combustible fuel source to a combustion zone of a furnace or boiler, the at least one combustible fuel having a sufficient level of one or more native halogens and/or native halogen-containing compounds; (II) providing one or more metal-bearing compounds to a combustion zone or flue gas stream of a furnace, or boiler, at a point that is both prior to entry of the flue gas into an SCR; (III) providing no additional halogen-containing compounds other than those natively contained in the at least one combustible fuel to a combustion zone or flue gas stream of a furnace, or boiler, prior to entry of the flue gas into an SCR, wherein the halogen portion of the one or more native halogen-containing compounds are liberated in the combustion zone or flue gas stream of the furnace or boiler and are converted to one or more corresponding gaseous hydrogen halide compounds; (IV) permitting the one or more metal-bearing compounds to catalyze the conversion of the corresponding one or more natively supplied hydrogen halides formed from the injection of the one or more halogen-containing compounds; and (V) permitting the resulting one or more corresponding elemental halogen compounds to react with gaseous mercury present in the combustion zone or flue gas stream of the furnace, or boiler, thereby resulting in oxidation of the gaseous mercury so as to convert the gaseous mercury into one or more corresponding mercury halides.

The various features of novelty which characterize the invention are pointed out with particularity in the claims annexed to and forming a part of this disclosure. For a better understanding of the invention, its operating advantages and specific benefits attained by its uses, reference is made to the accompanying drawings and descriptive matter in which exemplary embodiments of the invention are illustrated.

### BRIEF DESCRIPTION OF THE DRAWINGS

FIG. 1 is a schematic representation of a typical fossil fuel burning facility with an SCR system, and which includes a system for practicing the methods of the present invention;

FIG. 2 is a graph illustrating oxygen gas concentration during not only three different test conditions (colored and/or darker portions of the graph) but during the time before, between and after the three different test conditions;

FIG. 3 is a graph illustrating total mercury (Hg) concentration during not only three different test conditions (colored and/or darker portions of the graph) but during the time before, between and after the three different test conditions; and

FIG. 4 is a graph illustrating elemental mercury (Hg) concentration during not only three different test conditions (colored and/or darker portions of the graph) but during the time before, between and after the three different test conditions.

### DESCRIPTION OF THE INVENTION

The present invention relates generally to the field of emission control equipment for boilers, heaters, kilns, or other flue gas-, or combustion gas-, generating devices (e.g., those located at power plants, processing plants, etc.) and, in particular to a new and useful method and apparatus for: (i) reducing mercury levels in one or more flue gas and/or combustion gas streams using a combination of one or more halogens, or halogen-containing compounds, present in a combustible fuel and/or combustible material in conjunction with one or more metal-bearing compounds and up to about 25 ppm of one or more additionally supplied halogens, or additionally supplied halogen-containing compounds, in order to affect gas-phase mercury control; (ii) reducing mercury levels in one or more flue gas and/or combustion gas streams using a combination of one or more halogens, or halogen-containing compounds, present in a combustible fuel and/or combustible material in conjunction with one or more metal-bearing compounds and up to about 10 ppm of one or more additionally supplied halogens, or additionally supplied halogen-containing compounds, in order to affect gas-phase mercury control; and/or (iii) reducing mercury levels in one or more flue gas and/or combustion gas streams using a combination of one or more halogens, or halogen-containing compounds, present in a combustible fuel and/or combustible material in conjunction with one or more metal-bearing compounds where the need for any amount of additionally supplied halogens, or additionally supplied halogen-containing compounds, has been eliminated in order to affect gas-phase mercury control. In another embodiment, the method and apparatus of the present invention is designed to: (a) achieve a reduction in the level of one or more halogens, or halogen-containing compounds, necessary to affect gas-phase mercury control; (b) permit the oxidation of at least a portion of any elemental mercury (Hg⁰) contained in a flue gas and/or combustion gas stream; and/or (c) permit the oxidation of at least a portion of any elemental mercury (Hg⁰) contained in a flue gas and/or combustion gas stream so that the use of at least one post-oxidation mercury capture method and/or process results in the capture of at least a portion of oxidized mercury contained in the flue gas and/or combustion gas stream.

As used herein, “one or more additionally supplied halogens,” or “additionally supplied halogen-containing compounds,” means that one or more halogens, or halogen-containing compounds, are independently supplied to the combustible fuel and/or combustible material, or to any injection or addition point discussed herein to supplement any naturally and/or natively present halogens and/or halogen-containing compounds present in a combustible fuel and/or combustible material and/or to increase or provide a desired level or amount of any one or more halogens, or halogen-containing compounds, present in a flue gas and/or combustion gas stream where the combustible fuel and/or combustible material either totally lacks, or is deficient in the level or amount of, such one or more halogens and/or halogen-containing compounds.

While the present invention will be described in terms of SCR systems which use ammonia as the NOₓ reducing agent, since ammonia is frequently preferred for economic reasons, the present invention is not limited to ammonia based systems. The concepts of the present invention can be used in any system which uses an ammoniacal compound. As used in the present disclosure, an ammoniacal compound is a term meant to include compounds such as urea, ammonium sulfate, cyanuric acid, and organic amines as well as ammonia (NH₃). These compounds could be used as reducing agents in addition to ammonia, but as mentioned above, ammonia is frequently preferred for economic reasons. Some non-ammoniacal compounds such as carbon monoxide or methane can be used as well, but with loss in effectiveness.

Furthermore, although the present invention is described in terms of a mercury oxidation and capture method that utilizes a halogen compound that is in the form a halide salt (e.g., calcium bromide), the present invention is not limited to just this type of mercury oxidation and capture. Rather, any type of halogen-based mercury control method can be utilized in conjunction with the present invention as the present invention. In some embodiments, the present invention as the present invention also seeks to control simultaneously one or more of the amount and/or concentration of: (i) gas phase phosphorus and/or (ii) the nature, or type, of the selenium speciation. In other embodiments, the present invention seeks to control simultaneously the amount and/or concentration of gas phase phosphorus, the amount and/or concentration of one or more halogen compounds necessary for mercury control, and/or and the nature of the selenium speciation in a flue gas.

Although the present invention is described in relation to a boiler, or a fossil fuel boiler, it is not limited solely thereto. Instead, the present invention can be applied to any combustion source that generates NO regardless of whether such a combustion source is utilized in conjunction with a boiler, or a steam generator. For example, the present invention could be used in combination with a kiln, a heater, or any other type of combustion process that generates, in whole or in part, a flue gas or combustion gas containing NOₓ. Accordingly, the description below is to be construed as merely exemplary.

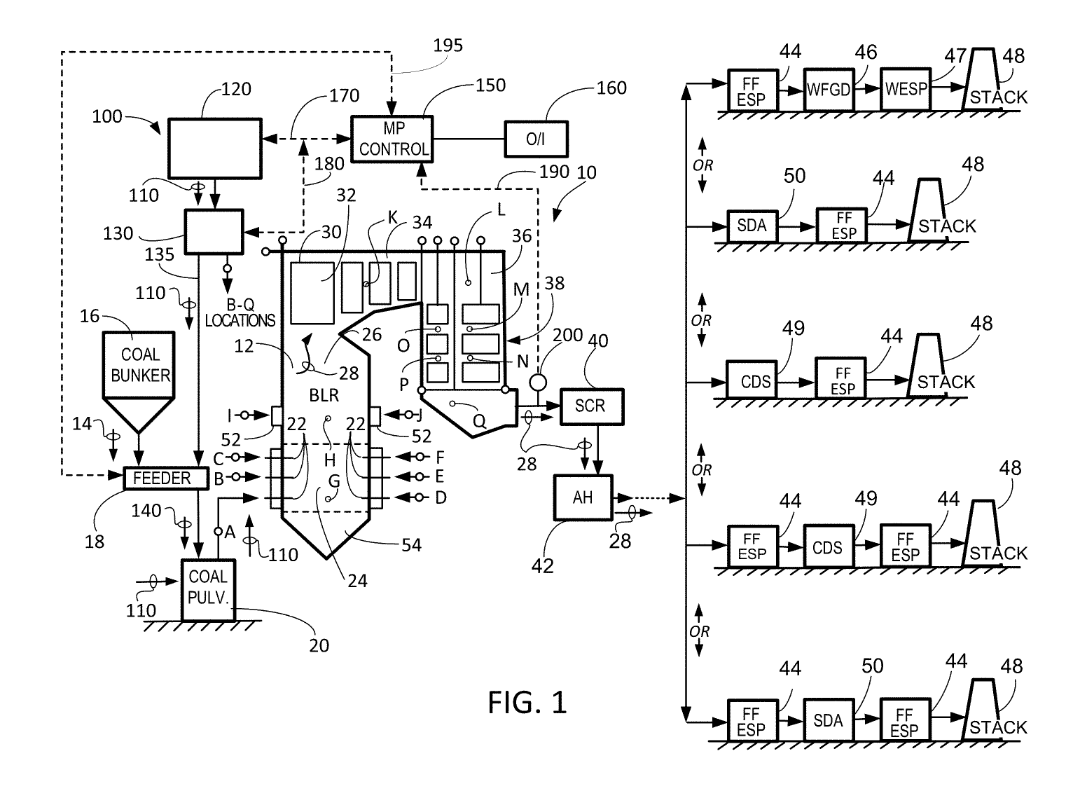

As illustrated in FIG. 1, the present invention may be applied to a boiler installation which employs a wet flue gas desulfurization (WFGD or wet scrubber) for removal of sulfur oxides from the flue gases, as shown in the upper right-hand side of FIG. 1. In this configuration, the wet scrubber is typically preceded (with respect to a direction of flue gas flow through the system) by a particulate collection device (PCD), advantageously a fabric filter (FF) bag house, or an electrostatic precipitator (ESP). If desired, there may also be provided a wet electrostatic precipitator (wet ESP or WESP) which may be provided as a final “polishing” stage for fine particulate or SO₃. Alternatively, the present invention may be applied to a system which employs a spray dryer apparatus (SDA) or dry scrubber for removal of sulfur oxides from the flue gases, as shown in the lower right-hand side of FIG. 1. In this configuration, the SDA or dry scrubber is typically followed (with respect to a direction of flue gas flow through the system) by a particulate collection device (PCD), advantageously a fabric filter (FF) or baghouse, an electrostatic precipitator (ESP) or even a wet electrostatic precipitator (wet ESP).

The use of halogens for the oxidation of mercury (Hg) in coal is well known in the industry. The early use of chlorides for mercury oxidation in a flue gas and/or combustion gas stream has given way to the use of bromine (or bromine-containing compounds) and/or iodine (or iodine-containing compounds) to accomplish the desired oxidation of mercury in a flue gas and/or combustion gas stream in order to achieve mercury MATS compliance. For those units with WFGD systems, which can become saturated with elemental mercury even with sufficient up-front mercury oxidation within the flue gas entering the WFGD system, both adsorbents such as activated carbon and absorbents, such as sulfides, can be used to sub-saturate the WFGD slurry liquor. Generally, the use of iodine has not been very common due to its order-of-magnitude greater cost than bromide.

Due to Internal Revenue Service (IRS) Section 45 tax credit availability every year about 100 million tons of coal are converted into the refined coal to take advantage of the Section 45 tax credits. About 40 percent of this converted coal is bituminous coal with significant native chlorine levels therein in combination with lower levels of other halogens and/or halogen compounds. In order to qualify for the Section 45 credits, refined coal must have 40 percent less mercury emissions and 20 percent less NOₓ emissions as compared to a baseline coal. In order to achieve the necessary level of mercury emission reduction it is necessary to add one or more halogens, or halogen-containing compounds, to one or more of the coal, the flue gas stream, the combustion gas stream, or to some other addition point to facilitate a greater level of oxidation of elemental mercury (Hg⁰) into ionized mercury (i.e., primarily Hg²⁺). As of late, the favored method for doing so utilizes bromine and/or one or more bromine-containing compounds, iodine and/or one or more iodine-containing compounds, or any combination thereof. The use of one or more of these halogen compounds converts elemental mercury into oxidized mercury which can then be removed either by added sorbents or flue gas desulfurization (FGD) systems. One problem with the addition of one or more halogens and/or halogen compounds to facilitate higher levels of mercury oxidation is that such one or more halogens, or halogen compounds, produce balance of plant issues such as corrosion issues, an increase in one or more selenium compounds in waste water discharges, and/or an increase in one or more halogen compounds in waste water discharges.

In bituminous coals there is enough halogen in the coal itself in the form of one or more native halogens (i.e., chlorine, fluorine, bromine and/or iodine) and/or one or more native halogen-containing compounds (e.g., one or more chlorine-containing compounds, one or more fluorine-containing compounds, one or more bromine-containing compounds and/or one or more iodine-containing compounds) present to affect mercury oxidation to a sufficient level. However, as will be detailed below in most coals a substantial portion of this halogen material is chlorine and while present at a sufficient level, chlorine compounds are not thermodynamically favored at the temperatures present in most flue gas and/or combustion gas streams. As a result a significant portion of the native chlorine is lost to non-productive side reactions and does not participate in the desired oxidation of elemental mercury into oxidized mercury. This in turn necessitates the need for the use of one or more additionally supplied halogens and/or additionally supplied halogen-containing compounds described above thereby resulting in the aforementioned balance of plant issues described above.

Any native chlorine present in a fuel source (e.g., a coal) will be released in the form of hydrochloric acid gas (HCl) upon combustion of such chlorine-containing fuel. The same can be said of any native bromine, fluorine and/or iodine present in the coal as the combustion of these additional halogen compounds will generate their respective hydrogen halides (i.e., HBr, HF and HI). In the absence of catalytic material the HF, HCl, HBr and/or HI is/are not effectively converted into F₂, Cl₂, Br₂ and/or I₂ (or some other suitable diatomic form) which can then react with the elemental mercury present in the flue gas to oxidize such elemental mercury and yield HgF₂, HgCl₂, HgBr₂ and/or HgI₂. In absence of the one or more metal additives of the present invention, although the HF, HCl, HBr and/or HI will be converted by the high temperature Deacon reaction in one or more of F₂, Cl₂, Br₂ and/or I₂ (or possibly even some other suitable diatomic form), one or more of the Griffin reactions detailed above can cause the amount of F₂, Cl₂, Br₂ and/or I₂ (or some other suitable diatomic form) to decrease thereby decreasing the efficiency of the oxidation of elemental mercury (Hg⁰) to ionized mercury (e.g., Hg²⁺).

In one instance, the problem associated with Cl₂ produced at higher temperatures by the Deacon reaction is that such Cl₂ is very susceptible to be reconverted into HCl by the Griffin reaction. In most instances, an SCR catalyst operates at a lower temperature range of about 650° F. to about 750° F. As a result any Cl₂ produced by the SCR catalyst is not susceptible to be reconverted back into HCl as the Griffin reaction is not right-side favored at such a lower temperature range. The same can be said regarding the other halogens, that is F₂, Br₂ and/or I₂, even though the thermodynamics of the Griffin reaction differ slightly for each of fluorine, chlorine, bromine and iodine due to the difference in their atomic radii and other properties.

Currently the dominant method for mercury oxidation and capture is via the use of a chemical additive such as bromine, a bromine compound, iodine and/or an iodine compound to one or more of the coal, the combustion gases or the flue gases. After the addition of the one or more halogens or halogen compounds the most common method to capture the oxidized mercury is to use one or more inorganic sulfur compounds (e.g., NaHS, etc.) and/or one or more organic sulfur compounds to convert the mercuric halide compounds into a highly insoluble mercuric sulfide compound that can be captured in one or more downstream air quality control systems (e.g., a WFGD, a DFGD, etc.).

In one embodiment, the metal-bearing compounds of the present invention is any iron compound (e.g., an iron oxide compound) that is able to undergo reduction in the combustion environments common to boilers, furnaces, power plants, etc. In another embodiment, the metal-bearing compound of the present invention can be a water soluble, or water insoluble, iron-bearing compound. Suitable water soluble iron-bearing inorganic compounds include, but are not limited to, iron (II) acetate (e.g., Fe(C₂H₃O₂)₂.4H₂O), iron (II) nitrate (e.g., Fe(NO₃)₂.6H₂O), iron (III) nitrate (e.g., Fe(NO₃)₃.6H₂O or Fe(NO₃)₃.9H₂O), iron (II) sulfate (e.g., FeSO₄.H₂O, FeSO₄.4H₂O, FeSO₄.5H₂O, or FeSO₄.7H₂O), iron (III) sulfate (e.g., Fe₂(SO₄)₃.9H₂O), or mixtures of two or more thereof. Although various hydrated forms of iron-bearing compounds are listed here, the present invention is not limited to just the hydrated forms listed above. Rather, if possible, any corresponding anhydrous form of the above listed iron-bearing compounds can also be utilized in conjunction with the present invention. Given this, when a metal-bearing compound and/or an iron-bearing compound is mentioned herein it should be interpreted to encompass both a hydrated form or an anhydrous form regardless of whether or not such a formula is given with “bound water.” Suitable water insoluble iron-bearing compounds include but are not limited to, metallic iron, one or more iron oxides, iron carbonate, or mixtures of two or more thereof. Additionally, a wide range of water soluble, or water insoluble, organic iron bearing compounds could be utilized in conjunction with the present invention. As will be discussed below, the metal-bearing compound, or in one embodiment the iron-bearing compound, of the present invention can be supplied in any desirable form including, but not limited to, powderized form, solid form, as an aqueous solution, as an aqueous suspension or emulsion, or any combination of two or more different forms of metal-bearing compounds, or in one embodiment two or more different forms of iron-bearing compounds. In still another embodiment, where two or more different forms of metal-bearing compounds, or two or more different forms of iron-bearing compounds, are supplied in conjunction with the present invention, the metal-bearing compound and/or the iron-bearing compound supplied via each different form can be the same or different.

In one particular embodiment, the present invention utilizes a combination of iron (III) oxide (Fe₂O₃), also known as red iron oxide or hematite. In the embodiment where iron (III) oxide is utilized the reactions of interest that occur in the combustion portion of a boiler or furnace are as shown below:

3Fe₂O₃(s)+CO(g)→2Fe₃O₄(s)+CO₂(g) (1)

Fe₃O₄(s)+CO(g)→3FeO(s)+CO₂(g) (2).

It should be noted that the Fe₃O₄, also known as black iron oxide or magnetite, of the first reaction above can also be written more accurately as FeO.Fe₂O₃. The FeO or iron (II) oxide, also known as ferrous oxide, which is generated due to the reduction of Fe₂O₃ is then available to tie-up, bind and/or sequester any PO gas present in the combustion zone, or the flue gas, of a boiler, or furnace, prior to arrival at the SCR. This PO gas will then form Fe—P compounds in particulate phase prior to arrival at the SCR. The particulate will pass through the catalyst and avoid the catalyst deterioration.

In another embodiment, the present invention can utilize iron (II) carbonate which is converted to the desired iron (II) oxide in the combustion zone via the reaction shown below:

FeCO₃(s)→FeO(s)+CO₂(g) (3).

In still another embodiment, the present invention can utilize a combination of one or more metal-bearing compounds (which again in one embodiment can be one or more iron-bearing compounds) and one or more halide compounds, with the proviso that the halide containing compound is not a metal halide or an iron halide. Thus, in this embodiment at least one metal bearing compound such as at least one iron-bearing compound is utilized in conjunction with at least one non-metal halogen-containing compound, or non-iron-containing compound. In still another embodiment, the at least one metal and/or iron compound has a generic formula of AX, where A is equal to iron, cobalt, copper and/or nickel and X is either an oxide or carbonate ion, anion, group, and/or moiety and the at least one halide compound has a generic formula of BY where B is any atom, element, or cation except for iron, cobalt, copper and/or nickel iron, cobalt, copper and/or nickel and Y is a halide selected from fluorine, chlorine, bromine or iodine.

In one embodiment, suitable halides for use in conjunction with the present invention include, but are not limited to, potassium bromide, potassium chloride, potassium fluoride, potassium iodide, sodium bromide, sodium chloride, sodium fluoride, sodium iodide, calcium bromide, calcium chloride, calcium fluoride, calcium iodide, aluminum bromide, aluminum chloride, aluminum fluoride, aluminum iodide, other metal halides (e.g., bromides, chlorides, fluorides and/or iodides) with the proviso that the metal is not iron, or any mixture of two or more thereof.

In still another embodiment, any one or more halide compounds in accordance with the proviso defined above can be used in combination with one or more non-halide containing metal compounds. In this embodiment, it is possible to use a combination of one or more iron-bearing compounds in conjunction with a minor amount of one or more other metal-bearing compounds where the minor metal-bearing compound is selected from one or more copper-bearing compounds, one or more cobalt-bearing compounds, one or more nickel-bearing compounds, or any combination of two or more minor metal-bearing compound minor metal-bearing compounds selected from any combination of the copper, cobalt and/or nickel compounds discussed herein.

In still another embodiment, the present invention utilizes a metal-bearing additive that is a combination of one or more iron-bearing compounds in combination with about 0.2 weight percent to about 0.5 weight percent, based on the total weight of the additive, of one or more minor metal-bearing compound selected from one or more copper-bearing compounds, one or more cobalt-bearing compounds, one or more nickel-bearing compounds, or any combination of two or more minor metal-bearing compound minor metal-bearing compounds. In another embodiment, the present invention utilizes a metal-bearing additive that is a combination of one or more iron-bearing compounds in combination with about 0.25 weight percent to about 0.45 weight percent, based on the total weight of the additive, of one or more minor metal-bearing compound selected from one or more copper-bearing compounds, one or more cobalt-bearing compounds, one or more nickel-bearing compounds, or any combination of two or more minor metal-bearing compound minor metal-bearing compounds. In still another embodiment, the present invention utilizes a metal-bearing additive that is a combination of one or more iron-bearing compounds in combination with about 0.3 weight percent to about 0.4 weight percent, based on the total weight of the additive, of one or more minor metal-bearing compound selected from one or more copper-bearing compounds, one or more cobalt-bearing compounds, one or more nickel-bearing compounds, or any combination of two or more minor metal-bearing compound minor metal-bearing compounds. In still yet another embodiment, the present invention utilizes a metal-bearing additive that is a combination of one or more iron-bearing compounds in combination with about 0.35 weight percent, based on the total weight of the additive, of one or more minor metal-bearing compound selected from one or more copper-bearing compounds, one or more cobalt-bearing compounds, one or more nickel-bearing compounds, or any combination of two or more minor metal-bearing compound minor metal-bearing compounds. Here, as well as elsewhere in the specification and claims, individual range values can be combined to form additional and/or non-disclosed ranges.

In still another embodiment, the present invention utilizes a metal-bearing additive that is a combination of one or more iron-bearing compounds in combination with about 0.2 weight percent to about 0.5 weight percent, based on the total weight of the additive, of one or more minor metal-bearing compound selected from one or more copper-bearing compounds. In another embodiment, the present invention utilizes a metal-bearing additive that is a combination of one or more iron-bearing compounds in combination with about 0.25 weight percent to about 0.45 weight percent, based on the total weight of the additive, of one or more minor metal-bearing compound selected from one or more copper-bearing compounds. In still another embodiment, the present invention utilizes a metal-bearing additive that is a combination of one or more iron-bearing compounds in combination with about 0.3 weight percent to about 0.4 weight percent, based on the total weight of the additive, of one or more minor metal-bearing compound selected from one or more copper-bearing compounds. In still yet another embodiment, the present invention utilizes a metal-bearing additive that is a combination of one or more iron-bearing compounds in combination with about 0.35 weight percent, based on the total weight of the additive, of one or more minor metal-bearing compound selected from one or more copper-bearing compounds. Here, as well as elsewhere in the specification and claims, individual range values can be combined to form additional and/or non-disclosed ranges.

As used herein, any metal-bearing compound suitable for use in conjunction with the present invention can be utilized in a hydrated or non-hydrated form. As such, reference to any metal-bearing compound, and in one embodiment an iron-bearing compound, by definition includes any hydrated forms that exists whether or not specifically mentioned by chemical formula.

As is known in the art, (see, e.g., United States Patent Application Publication No. 2008/0107579 the text of which is hereby incorporated by reference as though fully set forth herein) halogen-containing compounds are utilized to oxidize elemental mercury present in a flue, or combustion, gas. Due to this oxidation reaction, the halide portion of a suitable halogen-containing compound permits elemental mercury to be converted into a more favorable form for subsequent capture, or sequestration, via one or more suitable environmental control technologies (e.g., a wet scrubber or spray dry absorber (SDA), a flue gas desulfurization system (FGD), a powdered activated carbon system (PAC), or a particulate collecting system such as a fabric filter (FF) or an electrostatic precipitator (ESP)). In one instance, as is known in the art, the addition of one or more suitable halogen-containing compounds also increases the amount of mercury that is particulate-bound. Given that numerous patents and published applications detail the manner by which suitable halogen-containing compounds permit the increased recovery of mercury from a flue, or combustion, gas, a detailed discussion hereof is omitted for the sake of brevity.

In any of the above embodiments, the suitable one or more metal-bearing compounds, or in one embodiment the one or more iron-bearing compounds, and if so desired the one or more halide compounds, can be added to the coal via one or more pulverizers. In still another embodiment, the one or more metal-bearing compounds, or in one embodiment the one or more iron-bearing compounds, and if so desired the one or more halide compounds, of the present invention can be added to the combustion zone of a boiler and/or furnace via one or more suitable supply lines designed to deliver a powderized, solid, aqueous suspension, suspension, or aqueous solution of the one or more iron-bearing compounds and/or the one or more halide compounds to the combustion zone of a furnace and/or boiler. To this end, FIG. 1 illustrates several embodiments of suitable design schemes for accomplishing this result.

Referring to FIG. 1, there is illustrated a schematic representation of a typical fossil fuel burning facility, generally designated 10, with an SCR system, and which includes a system for practicing the methods of the present invention. As shown, boiler 12 is provided for extracting the heat from the combustion of a fossil fuel, such as coal, through combustion with an oxidant, typically air. The heat is transferred to a working fluid, such as water, to generate steam used to either generate power via expansion through a turbine generator apparatus (not shown) or for industrial processes and/or heating.

The raw coal 14 must be crushed to a desired fineness and dried to facilitate combustion. Raw coal 14 is temporarily stored in a coal bunker 16 and then transferred by means of a gravimetric or volumetric feeder 18 to one or more coal pulverizers 20. In the embodiment shown in FIG. 1, there are six (6) coal pulverizers, identified as coal pulverizers A-F. As is known to those skilled in the art, each coal pulverizer 20 grinds the coal to a desired fineness (e.g., 70 percent through 200 mesh) and as it is ground, hot primary air from primary air fans (not shown) is conveyed into each coal pulverizer 20 to preheat and remove moisture from the coal to desired levels as it is ground. The primary air is also used to convey the pulverized coal (PC) out of each coal pulverizer 20 and delivers it along a plurality of pulverized coal supply lines (one such burner line is identified at A in FIG. 1; a single coal pulverizer 20 may supply coal through 4 to 8 pulverized coal supply lines) to the burners 22 on the front and rear walls of the boiler 12. Typically, the burners 22 are located in spaced elevations on one or both of the opposed front and rear walls of the boiler 12, or at the corners of the boiler in installations known as corner-fired or tangentially-fired units (not shown). The present invention can be utilized in conjunction with, but is not limited solely to, single-wall fired, opposed-wall fired and corner- or tangentially-fired units. Typically, a single coal pulverizer 20 only provides coal to a single elevation of burners 22 on a wall. Thus, in the embodiment shown in FIG. 1, the six coal pulverizers A-F supply corresponding burner elevations A-F. However, as is known to those skilled in the art, other pulverizer and burner configurations are known (e.g., single pulverizers supplying burners on multiple walls and/or elevations or multiple pulverizers supplying burners on a single elevation) and the present invention applies to any such configurations.

The combustion process begins in the burner zone 24 of the boiler 12's furnace 26, releasing heat and creating hot flue gas 28 which is conveyed upwardly to the upper portion 30 of the boiler 12, across heating surfaces schematically indicated as rectangles 32. The flue gas 28 is then conveyed across the heating surfaces in the pendant convection pass 34, into the upper portion 36 of the horizontal convection pass 38. The flue gas 28 is then conveyed through a selective catalytic reduction (SCR) apparatus 40 where NOₓ in the flue gas is reduced, and then through primary and secondary air heater devices schematically indicated at 42. The air heaters 42 extract additional heat from the flue gas 28, lowering the temperature of the flue gas, and preheating the incoming air used for combustion.

As illustrated in FIG. 1, and downstream of the air heaters 42, the flue gas 28 undergoes further treatment for the removal of particulates and sulfur oxides. Two typical configurations of the downstream equipment employed to accomplish these tasks are shown on the right-hand side of FIG. 1. The first equipment configuration in FIG. 1 comprises a particulate collection device (PCD) schematically indicated at 44, for removal of particulates from the flue gas 28, and which may comprise in practice a fabric filter or an electrostatic precipitator. Downstream of the PCD 44 there is provided a wet flue gas desulfurization (WFGD) device, also known as a wet scrubber, for removal of sulfur oxides from the flue gas 28. The cleaned, scrubbed flue gas may (optionally) be conveyed through a wet ESP 47 for removal of fine particulate or SO₃, and then conveyed to stack 48 for discharge to the atmosphere.

The second equipment configuration in FIG. 1 comprises a spray dryer apparatus (SDA) schematically indicated at 50, also known as a dry scrubber, for removal of sulfur oxides from the flue gas 28. Downstream of the SDA 50 there is provided a particulate collection device (PCD) 44, as described above, for removal of particulates from the flue gas 28. The cleaned, scrubbed flue gas is then conveyed to stack 48 for discharge to the atmosphere.

The third equipment configuration in FIG. 1 comprises a circulating dry scrubber (CDS) schematically indicated at 49, for removal of sulfur oxides from the flue gas 28. Downstream of CDS 49 there is provided a particulate collection device (PCD) 44 for removal of particulates from the flue gas 28. As in the embodiments above, PCD 44 may comprise any suitable particulate collection device including, but not limited to, a fabric filter or an electrostatic precipitator as described above. The cleaned, scrubbed flue gas is then conveyed to stack 48 for discharge to the atmosphere.

The fourth equipment configuration in FIG. 1 comprises a first particulate removal device in the form of an electrostatic precipitator (ESP) which is schematically indicated at 44. ESP 44 is configured to remove fine particulates from flue gas 28. Downstream of ESP 44 there is provided a circulating dry scrubber (CDS) schematically indicated at 49, for removal of sulfur oxides from the flue gas 28. Downstream of CDS 49 there is provided a second particulate collection device (PCD) 44 for removal of any remaining particulates from the flue gas 28. As in the embodiments above, PCD 44 may comprise any suitable particulate collection device including, but not limited to, a fabric filter or an electrostatic precipitator as described above. The cleaned, scrubbed flue gas is then conveyed to stack 48 for discharge to the atmosphere. In another embodiment, ESP 44 could be interchangeably replaced with a fabric filter unit.

The fifth equipment configuration in FIG. 1 comprises a first particulate removal device in the form of either a fabric filter or an electrostatic precipitator (ESP) which is schematically indicated at 44. FF/ESP 44 is configured to remove fine particulates from flue gas 28. Downstream of FF/ESP 44 there is provided a spray dryer apparatus (SDA) schematically indicated at 50, also known as a dry scrubber, for removal of sulfur oxides from the flue gas 28. Downstream of SDA 50 there is provided a second particulate collection device (PCD) 44 for removal of any remaining particulates from the flue gas 28. As in the embodiments above, PCD 44 may comprise any suitable particulate collection device including, but not limited to, a fabric filter or an electrostatic precipitator as described above. The cleaned, scrubbed flue gas is then conveyed to stack 48 for discharge to the atmosphere.

In order to further reduce NOₓ emissions, some boilers 12 employ staged combustion wherein only part of the stoichiometric amount of air is provided in the main burner zone 24, with the balance of the air for combustion, together with any excess air required due to the fact that no combustion process is 100 percent efficient, is provided above the burner zone 24 via over fire air (OFA) ports 52. If staged combustion is employed in a boiler 12, due to the reduced air supplied to the burner zone 24, a reducing atmosphere is created in the lower portion of the furnace 26, including the hopper region 54.

In accordance with a first embodiment of the present invention, one or more metal-bearing compounds, or in one embodiment the one or more iron-bearing compounds, and if so desired one or more suitable halide compounds, are added to the one or more coal pulverizers 20 prior to supplying the pulverized coal to the one or more burners 22. The system and apparatus for accomplishing this desired result is also shown in FIG. 1, generally designated 100. The system 100 comprises a storage means 120 for temporarily storing the one or more metal-bearing compounds and/or the metal-bearing additive, and if so desired the mercury reducing compound, generally designated 110; delivery means 130, 135 for conveying the compound 110 to a desired location, including valves, seals, etc. as required; and control means 150, advantageously microprocessor-based control means, which are accessed via an operator via human operator interface (I/O) station 160, which includes display and data collection and storage means as required. Although not illustrated individually, the system of the present invention can, in one embodiment, utilize independent storage, delivery and control means (in accordance with those described above) for each individual metal-bearing compound or compounds and/or each individual halide compound or compounds. In still another embodiment, the system of the present invention can comprise one set of storage, delivery and control means for the metal-bearing compound or compounds, utilized herein and one set of storage, delivery and control means (in accordance with those described above) for the one or more halide compound or compounds utilized herein.

In FIG. 1, the raw coal 14 to which the one or more metal-bearing compounds or metal-bearing additive 110 has been added is referred to as 140. As used herein, the term “metal-bearing additive” is defined to refer to a metal-bearing mixture that contains at least two different metal compounds selected from iron and one or more of copper, cobalt and/or nickel. Advantageously, the one or more metal-bearing compounds or metal-bearing additive 110 may be provided along with the raw coal 14 via the feeder 18, which permits close control and measurement of the delivery of both raw coal 14 and metal-bearing compounds or metal-bearing additive 110 into the coal pulverizer 20. Alternatively, the one or more metal-bearing compounds or metal-bearing additive 110 may be provided directly into the coal pulverizer 20 and/or directly into one or more individual burner lines A-F providing the pulverized coal to individual burners 22, with suitable sealing devices against the positive pressure within the coal pulverizer 20 or burner lines A-F. The delivery means may be slurry-based or pneumatic as required by the particulars of the one or more metal-bearing compounds or metal-bearing additive 110 and the amount and location of introduction into the flue gas 28. An interconnected arrangement of control or signal lines 170, 180, 190 and 195 interconnect these various devices to provide control signals, one or more metal-bearing compounds or metal-bearing additive 110 level signals, and one or more total mercury concentration level signals and/or elemental mercury concentration level signals in the flue gas 28 (from one or more sensors represented by reference numeral 200) to permit the introduction of the iron-based phosphorus reducing compound 110 into the flue gas 28 to be controlled by a human operator, or automatically controlled. However, if one or more suitable real-time sensors 200 for measuring levels of one or more of total gaseous mercury and/or gaseous elemental mercury in the flue gas 28 is not available, flue gas samples may instead be taken at the location 200 for later laboratory analysis via suitable test methods, which may be inductively coupled plasma-mass spectrometry (ICP-MS). Based upon the laboratory results, a human operator could then use the operator interface 160 to manually input a desired set-point into control means 150 for the amount of one or more metal-bearing compounds or metal-bearing additive 110 introduced into the flue gas 28. Provided that subsequent laboratory analyses do not indicate any significant variation in either one or more of total gaseous mercury levels and/or gaseous elemental mercury levels in the flue gas 28, there may be no need for real-time, close control of the introduction of one or more metal-bearing compounds or metal-bearing additive 110. Instead, the amount of one or more metal-bearing compounds or metal-bearing additive 110 introduced into the flue gas 28 may be simply a function of boiler load or coal feed rate values.

In still yet another embodiment, the present invention utilizes a metal-bearing additive formed from the combination of iron (III) oxide (i.e., Fe₂O₃), also known as red iron oxide or hematite, with one or more copper-bearing compounds. In this case, the metal-bearing additive can be added at any suitable point post-combustion and pre-SCR in order to affect the desired mercury oxidation in the flue gas of a boiler, or furnace, prior to arrival at the SCR. In particular, the metal-bearing additive can be supplied at one or more of the locations G through Q shown in FIG. 1. More particularly, the metal-bearing additive can also be provided into the flue gas 28 at one or more of the following locations:
G: into or below the burner zone 24, in one or more of the front, rear or side walls, via means separate from the burners 22;
H: into the furnace 26 at a location above the burner zone 24, in one or more of the front, rear or side walls;
I, J: into the furnace 26 in the vicinity of or via the OFA ports 52 on one or both of the front or rear walls;
K: into the boiler 12 in the pendant convection pass 34;
L: into the boiler 12 in the upper portion 36 of the horizontal convection pass 38;
M, N, O, P: into the boiler 12 in the horizontal convection pass 38; and/or
Q: into the boiler 12 in the hopper region below the horizontal convection pass 38.

Given the above, it should be noted that in addition to the introduction of the one or more metal-bearing additive metal-bearing additive, the above-mentioned systems, methods and/or control apparatuses and/or technologies can also be utilized to introduce one or more halide compounds in accordance with the present invention as detailed above. Thus, in one embodiment, the present invention is directed to a system whereby the one or more metal-bearing compounds and/or metal-bearing additive and, if so desired, the one or more halide compounds are supplied in any manner per the various methods and/or systems described herein. In another embodiment, each type of compound, or even each separate compound regardless of type, can be supplied individually. In still another embodiment, any combination of two or more compounds regardless of type (i.e., whether a metal-bearing compound, metal-bearing additive and/or a halide compound) can be supplied together so long as the one compound does not react detrimentally with the other compound.

In still another embodiment, the metal-bearing compound, or in one case the iron-bearing compound, and the halide compound of the present invention can be added via separate compounds or can be added via the same compound and can be supplied in any suitable manner, including the manner detailed in the FIG. 1. Suitable iron-bearing compounds for use as the metal bearing compound of the present invention include, but are not limited to, powderized, solid, aqueous (be it an aqueous-based suspension or aqueous-based emulsion) and/or water soluble or water insoluble forms of iron-bearing compounds including, but not limited to, metallic iron, one or more iron oxides, iron carbonate, iron (II) acetate (e.g., Fe(C₂H₃O₂)₂.4H₂O), iron (II) nitrate (e.g., Fe(NO₃)₂.6H₂O), iron (III) nitrate (e.g., Fe(NO₃)₃.6H₂O or Fe(NO₃)₃.9H₂O), iron (II) sulfate (e.g., FeSO₄.H₂O, FeSO₄.4H₂O, FeSO₄.5H₂O, or FeSO₄.7H₂O), iron (III) sulfate (e.g., Fe₂(SO₄)₃.9H₂O), iron (II) bromide (e.g., FeBr₂), iron (III) bromide (e.g., FeBr₃, Fe₂Br₆, or FeBr₃.6H₂O), iron (II) chloride (e.g., FeCl₂, FeCl₂.2H₂O, or FeCl₂.4H₂O FeBr₂), iron (III) chloride (e.g., FeCl₃, Fe₂Cl₆, FeCl₃.2½H₂O, or FeCl₃.6H₂O), iron (II) iodide (e.g., FeI₂ or FeI₂.4H₂O), iron (III) iodate (e.g., Fe(IO₃)₃), or mixtures of two or more thereof. Although various hydrated forms of iron-bearing compounds are listed here, the present invention is not limited to just the hydrated forms listed above. Rather, if possible, any corresponding anhydrous form of the above listed iron-bearing compounds can also be utilized in conjunction with the present invention. Given this, when an iron-bearing compound is mentioned herein it should be interpreted to encompass both a hydrated form or an anhydrous form regardless of whether or not such a formula is given with “bound water.” Suitable halide compounds include, but are not limited to, potassium bromide, potassium chloride, potassium fluoride, potassium iodide, sodium bromide, sodium chloride, sodium fluoride, sodium iodide, calcium bromide, calcium chloride, calcium fluoride, calcium iodide, aluminum bromide, aluminum chloride, aluminum fluoride, aluminum iodide, other metal halides (e.g., bromides, chlorides, fluorides and/or iodides) with the proviso that the metal is not iron, or any mixture of two or more thereof. If an existing skid is used then one or more aqueous reagents can be pumped via positive displacement pumps from a storage tank to the one or more coal feeders where the reagent is sprayed on the coal as the coal passes on a feeder belt upstream of the pulverizers. In this instance, if so utilized the one or more halide compounds are chosen to be soluble in water, or an aqueous-based solvent. Suitable halides soluble halides include, but are not limited to, potassium bromide, potassium chloride, potassium fluoride, potassium iodide, sodium bromide, sodium chloride, sodium fluoride, sodium iodide, calcium bromide, calcium chloride, calcium iodide, aluminum bromide, aluminum chloride, aluminum iodide, or any mixtures of two or more thereof. In still another embodiment, other transition metal halides (e.g., bromides, chlorides, fluorides and/or iodides) that are not iron halides can be utilized so long as such compounds are, in this embodiment, soluble in water, or an aqueous-based solvent.

As discussed above in part and expanded below, suitable metal-bearing compounds include, but are not limited to, water soluble or water insoluble compounds, be they inorganic or organic compounds, of iron, copper, cobalt, nickel, or mixtures of two or more thereof. Suitable iron-bearing compounds include, but are not limited to, powderized, solid, aqueous (be it an aqueous-based suspension or aqueous-based emulsion) and/or water soluble forms of iron-bearing compounds including, but not limited to, metallic iron, one or more iron oxides, iron carbonate, iron (II) acetate (e.g., Fe(C₂H₃O₂)₂.4H₂O), iron (II) nitrate (e.g., Fe(NO₃)₂.6H₂O), iron (III) nitrate (e.g., Fe(NO₃)₃.6H₂O or Fe(NO₃)₃.9H₂O), iron (II) sulfate (e.g., FeSO₄+H₂O, FeSO₄.4H₂O, FeSO₄.5H₂O or FeSO₄.7H₂O), iron (III) sulfate (e.g., Fe₂(SO₄)₃.9H₂O), iron (II) bromide (e.g., FeBr₂), iron (III) bromide (e.g., FeBr₃, Fe₂Br₆ or FeBr₃.6H₂O), iron (II) chloride (e.g., FeCl₂, FeCl₂.2H₂O or FeCl₂.4H₂O FeBr₂), iron (III) chloride (e.g., FeCl₃, Fe₂Cl₆, FeCl₃.2½H₂O or FeCl₃.6H₂O), iron (II) iodide (e.g., FeI₂ or FeI₂.4H₂O), iron (III) iodate (e.g., Fe(IO₃)₃), or mixtures of two or more thereof. Suitable copper-bearing compounds include, but are not limited to, powderized, solid, aqueous (be it an aqueous-based suspension or aqueous-based emulsion) and/or water soluble or water insoluble forms of copper-bearing compounds including, but not limited to, metallic copper, copper acetate (e.g., Cu(C₂H₃O₂)₂.CuO.6H₂O or Cu(C₂H₃O₂)₂.H₂O), copper bromate (e.g., Cu(BrO₃)₂.6H₂O), copper bromide (e.g., CuBr, Cu₂Br₂ or CuBr₂), copper trioxybromide (e.g., CuBr₂.3Cu(OH)₂), copper carbonate or basic copper carbonate (e.g., Cu₂CO₃, CuCO₃.Cu(OH)₂ or 2CuCO₃.Cu(OH)₂), copper chloride (e.g., CuCl, Cu₂Cl₂, CuCl₂ or CuCl₂.2H₂O), copper fluoride (e.g., CuF, Cu₂F₂, CuF₂ or CuF₂.2H₂O), copper hydroxide (e.g., Cu(OH)₂), copper iodate (e.g., Cu(IO₃)₂ or Cu₃(IO₃)₆.2H₂O), copper iodide (e.g., CuI or Cu₂I₂), copper nitrate (e.g., Cu(NO₃)₂.H₂O or Cu(NO₃)₂.3H₂O), copper oxide (e.g., Cu₂O, CuO, CuO₂.H₂O or Cu₄O), copper sulfate (e.g., Cu₂SO₄, CuSO₄ or CuSO₄.5H₂O), or mixtures of two or more thereof.

Suitable cobalt-bearing compounds include, but are not limited to, powderized, solid, aqueous (be it an aqueous-based suspension or aqueous-based emulsion) and/or water soluble or water insoluble forms of cobalt-bearing compounds including, but not limited to, metallic cobalt, cobalt (III) acetate (e.g., Co(C₂H₃O₂)₃), cobalt (II) acetate (e.g., Co(C₂H₃O₂)₂.4H₂O), cobalt (II) benzoate (e.g., Co(C₇H₅O₂)₂.4H₂O), cobalt boride (e.g., CoB), cobalt (II) bromate (e.g., Co(BrO₃)₂.6H₂O), cobalt (II) bromide (e.g., CoBr₂ or CoBr₂.6H₂O), cobalt (II) carbonate (e.g., CoCO₃), basic cobalt (II) carbonate (e.g., 2CoCO₃.3Co(OH)₂.H₂O), cobalt (II) chlorate (e.g., Co(ClO₃)₂.6H₂O), cobalt (II) perchlorate (e.g., Co(ClO₄)₂, Co(ClO₄)₂.5H₂O, or Co(ClO₄)₂.6H₂O), cobalt (II) chloride (e.g., CoCl₂, CoCl₂.2H₂O, or CoCl₂.6H₂O), cobalt (III) chloride (e.g., CoCl₃), cobalt (II) citrate (e.g., Co(C₆H₅O₇)₂.2H₂O), cobalt (ii) fluoride (e.g., CoF₂ or CoF₂.4H₂O), cobalt (III) fluoride (e.g., CoF₃), cobalt fluoride (e.g., Co₂F₆.7H₂O), cobalt (II) hydroxide (e.g., Co(OH)₂), cobalt (III) hydroxide (e.g., Co₂O₃.3H₂O), cobalt (II) iodate (e.g., Co(IO₃)₂ or Co(IO₃)₂.6H₂O), cobalt (II) iodide (e.g., CoI₂, CoI₂.2H₂O, or CoI₂.6H₂O), cobalt (II) nitrate (e.g., Co(NO₃)₂.6H₂O), cobalt (II) oxide (e.g., CoO), cobalt (III) oxide (e.g., Co₂O₃), cobalt (II, III) oxide (e.g., Co₃O₄), cobalt (II) sulfate (e.g., CoSO₄, CoSO₄.H₂O, CoSO₄.6H₂O, or CoSO₄.7H₂O), cobalt (III) sulfate (e.g., Co₂(SO₄)₃.18H₂O), cobalt disulfide (e.g., CoS₂), cobalt monosulfide (e.g., CoS), cobalt (II) sulfite (e.g., CoSO₃.5H₂O), cobalt (II) tungstate (e.g., CoWO₄), one or more cobalt (II) or cobalt (III) inorganic complexes (e.g., CoBr₂.6NH₃, CoCl₂.2NH₃, CoI₂.6NH₃, etc.), or mixtures of two or more thereof. Suitable nickel-bearing compounds include, but are not limited to, powderized, solid, aqueous (be it an aqueous-based suspension or aqueous-based emulsion) and/or water soluble or water insoluble forms of nickel-bearing compounds including, but not limited to, metallic nickel, nickel acetate (e.g., Ni(C₂H₃O₂)₂ or Ni(C₂H₃O₂)₂.4H₂O), nickel bromate (e.g., Ni(BrO₃)₂.6H₂O), nickel bromide (e.g., NiBr₂ or NiBr₂.3H₂O), nickel carbonate or basic nickel carbonate (e.g., NiCO₃, 2NiCO₃.3Ni(OH)₂.4H₂O or zaratite), nickel chloride (e.g., NiCl₂ or NiCl₂.6H₂O), nickel fluoride (e.g., NiF₂), nickel hydroxide (e.g., Ni(OH)₂ or Ni(OH)₂.XH₂O), nickel iodate (e.g., Ni(IO₃)₂ or Ni(IO₃)₂.4H₂O), nickel iodide (e.g., NiI₂), nickel nitrate (e.g., Ni(NO₃)₂.6H₂O), nickel oxide (e.g., NiO), nickel sulfate (e.g., NiSO₄, NiSO₄.7H₂O or NiSO₄.6H₂O), or mixtures of two or more thereof.

In another embodiment, any combination of one or more of any of the iron-bearing compounds, copper-bearing compounds, cobalt-bearing compounds and/or nickel-bearing compounds discussed above can be combined together to form the metal-bearing additive of the present invention. Thus, any combination of two or more different metal-bearing compounds selected from the iron-bearing compounds, copper-bearing compounds, cobalt-bearing compounds and/or nickel-bearing compounds discussed above can be combined together to form the metal-bearing additive of the present invention.

It should be noted that although various hydrated forms of metal-bearing compounds are listed here, the present invention is not limited to just the hydrated forms listed above. Rather, if possible, any corresponding anhydrous form of the above listed metal-bearing compounds can also be utilized in conjunction with the present invention. Given this, when a metal-bearing compound is mentioned herein it should be interpreted to encompass both a hydrated form or an anhydrous form regardless of whether or not such a formula is given with “bound water.”

In still another embodiment, the present invention can entail the use of at least one kaolin-bearing compound to control gas phase sodium and potassium compounds as described in U.S. Pat. No. 8,303,919 the complete disclosure and teachings of which are hereby incorporated herein by reference in their entirety.

In one embodiment, the present invention is advantageous in that it is applicable to both existing SCRs (retrofits) and new SCRs. Additionally, the present invention can be applied to plants that utilize biomass as a fuel source. In one embodiment, implementation of the present invention can be accomplished in a cost-effective manner utilizing low cost hardware designed to supply the necessary one or more metal-bearing compounds or metal-bearing additive to a combustion process. The present invention also does not affect the current design of boilers and SCRs.

In one embodiment, the amount of one or more metal-bearing compounds or metal-bearing additive utilized in conjunction with the present invention varies depending upon the phosphorus content in the coal to be burned. In one embodiment, the present invention is directed to a method and system whereby a stoichiometric excess one or more metal-bearing compounds or metal-bearing additive are supplied to any point prior to an SCR. While not wishing to be bound to any one theory, it has been found that by supplying a stoichiometric excess of one or more metals selected from iron, cobalt, copper, nickel or any mixture of any two or more thereof upstream of an SCR can result in the elimination of the need to supply one or more halogens, or halogen-containing compounds to the fuel (i.e., coal), the combustion gas and/or flue gas.

In another embodiment, the amount of metal-bearing compound, or metal-bearing compounds, utilized in conjunction with the present invention is within a given range when the coal utilized is a blend of Powder River Basin and any other type of coal, or any other single type of coal or blends of coals where the one or more types of coal are selected from one or more of lignite coal, sub-bituminous coal, bituminous coal, “steam coal” (which is generally defined as a grade of coal between bituminous coal and anthracite) and/or anthracite coal, or any mixtures of any two or more types of such coals. In this embodiment, the amount of the metal-bearing compound, or metal-bearing compounds, to any one or more of the types of coal discussed above is expressed as the amount of metal-bearing compound, or metal-bearing compounds, (hereinafter referred to as just “metal additive” in only this instance) in pounds for every 1,000 pounds of coal. In one embodiment, the amount of metal-bearing compound, or metal-bearing compounds, utilized is in the range of about 5 pounds of “metal additive” per 1,000 pounds of coal to about 20 pounds of “metal additive” per 1,000 pounds of coal. In another embodiment, the amount of metal-bearing compound, or metal-bearing compounds, utilized is in the range of about 5.5 pounds of “metal additive” per 1,000 pounds of coal to about 17.5 pounds of “metal additive” per 1,000 pounds of coal, or from about 6 pounds of “metal additive” per 1,000 pounds of coal to about 15 pounds of “metal additive” per 1,000 pounds of coal, or from about 7 pounds of “metal additive” per 1,000 pounds of coal to about 12.5 pounds of “metal additive” per 1,000 pounds of coal, or from about 7.5 pounds of “metal additive” per 1,000 pounds of coal to about 10 pounds of “metal additive” per 1,000 pounds of coal, or even from about 8 pounds of “metal additive” per 1,000 pounds of coal to about 9 pounds of “metal additive” per 1,000 pounds of coal. Here, as well as elsewhere in the specification and claims, individual range values can be combined to form additional and/or non-disclosed ranges.

In another embodiment, where both the one or more metal-bearing compounds (e.g., in one embodiment one or more iron-bearing compounds) and the one or more halogen-containing compounds as defined above are utilized, the amount of the one or more metal-bearing compounds as compared on a weight basis to the amount of the one or more halogen-containing compounds is in the range of about 95 weight parts metal-bearing compounds (or even metal-bearing additive) to about 5 weight parts of the one or more halogen-containing compounds. In another embodiment, the weight ratio of the one or more halogen-containing compounds to the one or more halogen-containing compounds is in the range of about 95:5 to about 75:25, or from about 93.5:6.5 to about 80:20, or from about 92:8 to about 82.5:17.5, or from about 91:9 to about 85:15, or even from about 90:10 to about 87.5:12.5. Thus, in one embodiment, the amount of the one or more halogen-containing compounds, if so utilized, can be calculated based on any of the above stated one or more metal-bearing compounds amounts via the ratios disclosed in this paragraph. Here, as well as elsewhere in the specification and claims, individual range values can be combined to form additional and/or non-disclosed ranges.

In another embodiment, the injection rate of the one or more halogen-containing compounds, if so utilized in conjunction with the present invention, for controlling mercury in a flue gas, or combustion gas, is based on a non-limiting example of a 100 MWe coal power plant. In this case, the injection rate for the one or more halogen-containing compounds, if in solution, is in the range of about 0.25 gallons per hour to about 10 gallons per hour, or from about 0.5 gallons per hour to about 5 gallons per hour, or even from about 1 gallon per hour to about 4 gallons per hour. In another embodiment, regardless of power plant or combustion plant size, the one or more halogen-containing compounds are supplied at any rate to a fuel (e.g., coal), a flue gas, or a combustion gas, sufficient to yield a concentration of halide (e.g., bromide, chloride or iodide) between 0 and about 25 ppm, or from about 0.5 ppm to about 22.5 ppm, or from about 1 ppm to about 20 ppm, or from about 2.5 ppm to about 17.5 ppm, or from about 5 ppm to about 15 ppm, or from about 7.5 ppm to about 12.5 ppm, or even about 10 ppm. Here, as well as elsewhere in the specification and claims, individual range values (even from different embodiments) can be combined to form additional and/or non-disclosed ranges. In still another embodiment, the present invention relies solely on the native halogen present in the fuel source and thus no (i.e., zero) additional halogen via one or more halogen-containing compounds is supplied to any of the flue, the combustion gas and/or the flue gas.

In still another embodiment, the one or more halogen-containing compounds utilized herein are selected from one or more chlorine-containing compounds, and in another embodiment, calcium chloride. In the instance where one or more chlorine-containing are utilized such a compound or compounds are supplied, regardless of power plant or combustion plant size, at any rate to a fuel (e.g., coal), a flue gas, or a combustion gas, sufficient to yield a concentration of chlorine between 0 and about 25 ppm, or from about 0.5 ppm to about 22.5 ppm, or from about 1 ppm to about 20 ppm, or from about 2.5 ppm to about 17.5 ppm, or from about 5 ppm to about 15 ppm, or from about 7.5 ppm to about 12.5 ppm, or even about 10 ppm. Here, as well as elsewhere in the specification and claims, individual range values (even from different embodiments) can be combined to form additional and/or non-disclosed ranges. In still another embodiment, the present invention relies solely on the native halogen present in the fuel source and thus no (i.e., zero) additional chlorine via one or more chlorine-containing compounds is supplied to any of the flue, the combustion gas and/or the flue gas.

In light of the above, one of skill in the art would recognize that the amount of the one or more metal-bearing compounds, or in one instance the one or more iron-bearing compounds, necessary to supply the desired amount of iron to a flue gas, or combustion gas, in accordance with the process of the present invention will vary depending upon the size of the device generating such flue gas, or combustion gas. The same can be said of the one or more halide compounds. That is, one of skill in the art would recognize that the amount of one or more halide compounds necessary to supply the desired amount of halide to a flue gas, or combustion gas, in accordance with the process of the present invention will vary depending upon the size of the device generating such flue gas, or combustion gas. Thus, the present invention is not limited to any specific rate or range of supply.

In another embodiment, for a 100 MWe coal power plant the amount of halide solution (25 weight percent solution) supplied to the flue gas, or combustion gas, is in the range of about 0.25 gallons per hour to about 6 gallons per hour, or from 0.5 gallons per hour to about 5 gallons per hour, or even from 1 gallon per hour to about 4 gallons per hour. Here, as well as elsewhere in the specification and claims, individual range values can be combined to form additional and/or non-disclosed ranges. However, as is noted above, the present invention is not limited to solely these supply rates. Rather, any supply rate can be used in order to achieve the desired concentration of halide.

As would be apparent to one of skill in the art, other additional factors can impact the amount of the one or more metal-bearing compounds, or in one instance the one or more iron-bearing compounds, supplied in connection with the various embodiments of the present invention. Such additional factors include, but are not limited to, the amount and/or type of mercury present in the coal, or other combustible fuel; the size and/or output of the boiler, heater, kiln, or other flue gas-, or combustion gas-, generating device; and the desired stoichiometric ratio to be achieved; the type and/or manner of combustion, the type and/or arrangement of any applicable equipment or structure.

In another embodiment, the one or more metal-bearing compounds, or in one instance the one or more iron-bearing compounds, and/or the one or more halide compounds utilized in conjunction with the present invention can be of any particle size and/or particle geometry. Suitable particle geometries include, but are not limited to, spherical, platelet-like, irregular, elliptical, oblong, or a combination of two or more different particle geometries. As would be apparent to those of skill in the art, each different compound, or even the same compound, can be supplied in the form of one or more particle geometries. In one embodiment, the one or more metal-bearing compounds, or in one instance the one or more iron-bearing compounds, and/or the one or more halide compounds of the present invention, if water soluble, can be supplied in solution form, either independently or together so long as the active components to be delivered to the flue, or combustion, gas do not adversely react. In such an instance, a solution concentration of at least about 15 weight percent of one or more water soluble metal-bearing compounds and/or one or more water soluble halide compounds is utilized. In another embodiment, a solution concentration of at least about 20 weight percent, at least about 25 weight percent, at least about 30 weight percent, at least about 35 weight percent, at least about 40 weight percent, at least about 45 weight percent, or even at least about 50 weight percent of more of the one or more water soluble metal-bearing compounds and/or the one or more water soluble halide compounds is utilized in conjunction with the present invention. Here, as well as elsewhere in the specification and claims, individual range values can be combined to form additional and/or non-disclosed ranges. As would be appreciated by those of skill in the art, the solution concentration of any one or more water soluble metal-bearing compounds and/or the one or more water soluble halide compounds should not, in one embodiment, exceed the solubility amount, respectively, for the one or more metal-bearing compounds and/or the one or more halide compounds.

In still another embodiment, the one or more metal-bearing compounds and/or the one or more halide compounds of the present invention can be supplied in a powdered form, a solution form, an aqueous suspension form, or a combination of two or more thereof. In the case of an aqueous suspension, the one or more metal-bearing compounds and/or the one or more halide compounds utilized in conjunction with the present invention should have a suitable particle size. Additionally, even absent the desire to place the one or more metal-bearing compounds and/or the one or more halide compounds of the present invention into an aqueous solution, the one or more metal-bearing compounds and/or the one or more halide compounds should have a suitable particle size that facilitates a higher degree of reactivity when placed into contact with a flue, or combustion, gas. In one embodiment, both of these conditions can be met, whether individually or in combination, by one or more metal-bearing compounds and/or one or more halide compounds where at least about 95 percent of the particles have a particle size of less than about 400 μm (microns), where at least about 95 percent of the particles have a particle size of less than about 350 μm (microns), where at least about 95 percent of the particles have a particle size of less than about 300 μm (microns), where at least about 95 percent of the particles have a particle size of less than about 250 μm (microns), where at least about 95 percent of the particles have a particle size of less than about 200 μm (microns), or even where at least about 95 percent of the particles have a particle size of less than about 175 μm (microns). Here, as well as elsewhere in the specification and claims, individual range values can be combined to form additional and/or non-disclosed ranges.

Although not limited hereto, a suitable iron compound for use in conjunction with the present invention is hematite (e.g., iron (III) oxide (Fe₂O₃). A suitable halide compound for use, if so desired, in conjunction with the present invention is calcium chloride.

In the instance where one or more aqueous suspensions is/are utilized in conjunction with the present invention, such aqueous suspension(s) can further comprise a suitable amount of one or more anti-settling, suspension, thickening or emulsification agents. Suitable anti-settling, suspension, thickening or emulsification agents include, but are not limited to, sodium polyacrylates, carbomers, acrylates, and inorganic thickening agents. Other suitable anti-settling, suspension, thickening or emulsification agents are known to those of skill in the art and as such a discussion herein is omitted for the sake of brevity. In another embodiment, a suitable suspension or emulsification can be achieved via agitation and does not necessarily require the use of one or more anti-settling, suspension, thickening or emulsification agents. In another embodiment, a combination of one or more anti-settling, suspension, thickening or emulsification agents can be utilized in combination with agitation.

In still another embodiment, the one or more metal-bearing compounds and/or the one or more halide compounds of the present invention should independently have a purity of at least about 50 weight percent, at least about 55 weight percent, at least about 60 weight percent, at least about 65 weight percent, at least about 70 weight percent, at least about 75 weight percent, at least about 80 weight percent, at least about 85 weight percent, at least about 90 weight percent, at least about 95 weight percent, or even at least about 99 weight percent or higher. Here, as well as elsewhere in the specification and claims, individual range values can be combined to form additional and/or non-disclosed ranges.

As for the portion of the one or more metal-bearing compounds that is not “a metal-bearing compound,” such impurities should be non-reactive in the environments present in conjunction with the present invention. Alternatively, if reactive, such impurities should either be easily captured, removed and/or sequestered, or should not add significantly to any further contamination of any catalyst downstream. In still another embodiment, the amount of phosphorus-containing compound impurities in any of the one or more metal-bearing compounds and/or the one or more halide compounds that are utilized in conjunction with the present invention should independently be less than about 5 weight percent, less than about 2.5 weight percent, less than about 1 weight percent, less than about 0.5 weight percent, less than about 0.25 weight percent, less than about 0.1 weight percent, or even less than about 0.01 weight percent. Here, as well as elsewhere in the specification and claims, individual range values can be combined to form additional and/or non-disclosed ranges. In still yet another embodiment, the amount of phosphorus-containing compound impurities in any of the one or more metal-bearing compounds and/or the one or more halide compounds that are utilized in conjunction with the present invention should be zero. That is, in this embodiment the one or more metal-bearing compounds and/or the one or more halide compounds that are utilized in conjunction with the present invention should independently be free from any phosphorus-containing compounds.

In another embodiment, the present invention is direct to a system and method for the injection of one or more metal-bearing compounds and one or more non-metal-containing halide (where the halide does not contain a metal selected from iron, copper, cobalt and/or nickel) compounds with coal in the furnace in order to replenish the active catalytic sites on the surface of SCR catalyst with iron, copper, cobalt and/or nickel active sites while simultaneously achieving mercury oxidation. In one instance, the injection material is a blend of one or more metal-bearing compounds discussed above (about 90 weight percent) and a non-metal-containing halogen compound (e.g., calcium chloride 10 weight percent). As is known to those of skill in the art, any iron, copper, cobalt and/or nickel that is present in coal ash (including but not limited to PRB coal ash) is not catalytically active as it bonds, or is bonded, with various silicates and/or alum mates in the coal combustion process. In PRB coal more than 90 percent of total iron, copper, cobalt and/or nickel occurs as a bonded mineral meaning that it is mostly trapped in glassy silica and/or alumina compounds during the combustion process thereby making it unavailable for any other chemical reaction. Thus, the present invention, by injecting iron, copper, cobalt and/or nickel separately, provides “free” iron, copper, cobalt and/or nickel that, while not wishing to be bound to any one theory, is believed to settle onto and/or be deposited onto the surface of fly ash which makes it available for further chemical reactions.

This blended material that contains “free” iron, copper, cobalt and/or nickel as defined above can then provide iron, copper, cobalt and/or nickel for increasing the catalytic activity and/or catalytic lifespan of the DeNOₓ catalyst while, if so provided, the halogen portion of the one or more halide compounds of the present invention acts to aid, or achieve, mercury oxidation. While not wishing to be bound to any one theory, is believed that when the fly ash gets deposited on the surface of SCR catalyst the iron, copper, cobalt and/or nickel on the surface of fly ash or iron deposited on catalyst as a result of the injection process provides sites onto which ammonia and NOₓ can react to form N₂ and water. As the iron, copper, cobalt and/or nickel is injected continuously at a low rate of injection, any active iron, copper, cobalt and/or nickel sites that become depleted are replaced by new iron, copper, cobalt and/or nickel sites at a reasonable rate thereby allowing for the extension and/or increase of catalytic lifespan and/or catalytic activity when compared to similar untreated catalyst as explained in detail above. The halogen portion of the halide compound, or compounds, oxidizes elemental mercury into its oxidized form and makes it easier for removal by a downstream wet or dry scrubber, or with PAC injection.

In one another embodiment, the present invention relates to method and/or apparatus that enables, permits and/or achieves a reduction in the injected amount of one or more halogen-containing compounds to achieve a desired level of mercury oxidation, or even the elimination of the need for injecting one or more halogen-containing compounds to achieve a desired level of mercury oxidation because the present invention advantageously converts any native halogens present in the fuel (e.g., coal) more efficiently through the use of one or more metal-bearing compounds to achieve a desired level of mercury oxidation without the need for, in some embodiments, any additionally supplied halogen-containing compounds. This embodiment of the present invention can be accomplished alone, or in combination, with any of the other embodiments of the present invention that are discussed above.

In light of the above, it has been unexpectedly discovered that the addition of at least one metal-bearing compound to a fuel (e.g., coal), a combustion gas, or a flue gas stream results in a reduction even in the elimination of the need to supply one or more additional sources of halogen-containing compounds at one or more levels necessary to affect gas-phase mercury control. In other words, the use of at least one metal-bearing compound according to the present invention has been unexpectedly discovered to catalyze, facilitate, or increase the amount and/or concentration of the one or more natively occurring halogen compounds in coal that are converted from their chemical form through such compound's corresponding hydrogen halide form (e.g., HBr, HCl, HF, and/or HI) to the corresponding molecular halogen form (Br₂, Cl₂, F₂, and/or I₂).

As discussed above, in various coal combustion processes the injection of one or more halogen-containing compounds is one method that can be utilized for mercury control via a mercury capture process based on such one or more halogen-containing compounds. However, one drawback to achieving mercury capture and/or reduction via the use of such one or more additionally injected halogen-containing compounds is the level of the one or more halogen-containing compounds necessary to accomplish a desired reduction level in the mercury concentration in a coal combustion flue gas. The necessary levels of the one or more halogen-containing compounds required to achieve the desired level of mercury capture can lead to the formation of undesirable levels of one or more halogen compounds such as hydrogen halides (e.g., HBr, HCl, HF, and/or HI) in order to have available a suitable concentration of one or more hydrogen halide compounds to be converted via, for example, a corresponding Deacon reaction such as the one above or another reaction that converts hydrogen halides to a corresponding molecular form of a halogen, into one or more corresponding molecular halogens (Br₂, Cl₂, F₂, and/or I₂). As is known by those of skill in the art, having a undesirable level of one or more hydrogen halide compounds in combustion, or flue, gas can lead to undesirable corrosion, acid rain (if such acid gases are emitted to the atmosphere), destruction or deactivation of downstream emission control equipment, poisoning or increased wear of one or more downstream catalyst compounds (e.g., one or more SCR catalysts), etc. As noted above, it is such molecular halogen compounds that affect the mercury capture by oxidizing the mercury in the combustion, or flue, gas from elemental mercury (Hg⁰) to ionic mercury (e.g., Hg²⁺) and then capturing the ionic mercury in a corresponding mercury halide compound (e.g., HgBr₂).

As noted above, in one embodiment the present invention through the use of one or more metal, or metal-bearing, compounds achieves a reduction in, or even an elimination of, the amount, level, or concentration of one or more additionally supplied halogen-containing compounds that are injected to affect mercury capture. In one embodiment, the present invention achieves a reduction of about 20 weight percent or percent by volume of the amount of one or more halogen-containing compounds necessary to achieve the same level of mercury capture through the use of one or more metal, or metal-bearing, compounds as compared to the amount of one or more halogen-containing compounds necessary without the use of the present invention's one or more metal, or metal-bearing, compounds. It should be noted that in this embodiment the one or more metal, or metal-bearing, compounds can be injected at any of the injection points detailed above. In still another embodiment, the present invention through the use of one or more metal, or metal-bearing, compounds or metal-bearing additives achieves a reduction of at least about 25 percent, at least about 30 percent, at least about 35 percent, at least about 40 percent, at least about 45 percent, at least about 50 percent, at least about 55 percent, at least about 60 percent, at least about 65 percent, at least about 70 percent, at least about 75 percent, at least about 80 percent, at least about 85 percent, at least about 90 percent, at least about 95 percent, or even a reduction of 100 percent, by weight or by volume, as compared to the amount of one or more halogen-containing compounds necessary without the use of the present invention's one or more metal, or metal-bearing, compounds. In the case where the reduction achieved by the present invention is 100 percent it is understood that the amount of native halogen present in the fuel source (e.g., coal) is sufficient enough that the one or more metal-bearing compounds or metal-bearing additive of the present invention together with the native halogen in the fuel source (e.g., coal) achieves a desired level of mercury oxidation without the use, or need, for any additionally supplied halogen-containing compounds. Here, as well as elsewhere in the specification and claims, individual numerical values can be combined to form additional and/or non-disclosed ranges.

Given the above, it should be noted that when numerical values are utilized herein with regard to an amount of a reduction that is achieved by one or more embodiments of the present invention, if such numerical values are stated in percentages these numerical values and/or ranges encompass separately both reductions measured in terms of weight and in terms of volume. Additionally, with regard to the terms of “amount” and “concentration,” the term “amount” is a broad term that is defined in a non-limiting manner to mean “a quantity of something, typically the total of a thing or things in number, size, value, or extent,” while “concentration” is a slightly more specific term that is defined in a non-limiting manner to mean “the amount of a specified substance in a unit amount of another substance.” Given these definitions, as used herein the term “amount” encompasses the definition of the term “concentration” for the purposes of the various embodiments of the present invention where a reduction in the amount of something is either discussed and/or claimed.

Any suitable amount of the one or more metal, or metal-bearing, compounds or metal-bearing additives of the present invention can be utilized in order to achieve the desired reduction in the amount and/or concentration of the one or more halogen-containing compounds necessary for mercury capture. Given this, this embodiment of the present invention is not limited to the injection of any one amount and/or concentration, or range of amounts and/or concentrations, of the one or more metal, or metal-bearing, compounds or metal-bearing additives of the present invention. Rather, the amount and/or concentration of the one or more metal, or metal-bearing, compounds or metal-bearing additives necessary to achieve the desired reduction in the amount and/or concentration of the one or more halogen-containing compounds needed to achieve the desired level of mercury capture will vary based on number of factors known to those of skill in the art. Such factors include, but are not limited to, the mercury level in the fuel (e.g., coal) to be combusted, the amount of fuel being burned in a given time period, the size of the plant burning the fuel (e.g., the generation capacity, the number of burners, etc.), etc. Some non-limiting examples of the amounts and/or concentrations of the one or more metal, or metal-bearing, compounds or metal-bearing additives that are used in conjunction with this embodiment of the present invention are discussed above with regard to other embodiments of the present invention.

In still yet another embodiment, the present invention relates to various methods for reducing the amount and/or concentration of one or more halogen-containing compounds used to achieve mercury capture in a flue gas regardless of the type of fossil fuel combusted so long as the combustion of the fossil fuel in question leads to the need to capture one or more forms of mercury, or mercury compounds.

In the case where the present invention relies solely on the native halogen present in the fuel source and thus no (i.e., zero) additional halogen via one or more halogen-containing compounds is supplied to any of the flue, the combustion gas and/or the flue gas, the native amount of halogen (i.e., the native amount of one or more of chlorine, fluorine, bromine and/or iodine) present in the fuel source (e.g., one or more types of coal as discussed above) is at least about 400 ppm by weight, at least about 425 ppm by weight, at least about 450 ppm by weight, at least 475 ppm by weight, at least about 500 ppm by weight, at least about 525 ppm by weight, at least about 550 ppm by weight, at least 575 ppm by weight, at least about 600 ppm by weight, at least about 625 ppm by weight, at least about 650 ppm by weight, at least 675 ppm by weight, at least about 700 ppm by weight, at least about 725 ppm by weight, at least about 750 ppm by weight, at least 775 ppm by weight, at least about 800 ppm by weight, at least about 825 ppm by weight, at least about 850 ppm by weight, at least 875 ppm by weight, at least about 900 ppm by weight, at least about 925 ppm by weight, at least about 950 ppm by weight, at least 975 ppm by weight, or even at least about 1000 ppm by weight based on the weight of the fuel (e.g., one or more types of coal as discussed above). Here, as well as elsewhere in the specification and claims, individual range values (even from different embodiments) can be combined to form additional and/or non-disclosed ranges.

Given the above, in another embodiment where some additional source of one or more halogen-containing compounds is supplied to one or more of any of the flue, the combustion gas and/or the flue gas, the fuel source (e.g., coal) utilized in conjunction with the present invention should contain at least a native halogen level based on the weight of the fuel of at least about 200 ppm, at least about 225 ppm, at least about 250 ppm, at least about 275 ppm, at least about 300 ppm, at least about 325 ppm, at least about 350 ppm, at least about 375 ppm, at least about 400 ppm, at least about 425 ppm, at least about 450 ppm, at least about 475 ppm, at least about 500 ppm, at least about 525 ppm, at least about 550 ppm, at least about 575 ppm, at least about 600 ppm, at least about 625 ppm, at least about 650 ppm, at least about 675 ppm, at least about 700 ppm, at least about 725 ppm, at least about 750 ppm, at least about 775 ppm, at least about 800 ppm, at least about 825 ppm, at least about 850 ppm, at least about 875 ppm, at least about 900 ppm, at least about 925 ppm, at least about 950 ppm, at least about 975 ppm, or even at least about 1000 ppm, so that the one or more metal-bearing compounds and/or metal-bearing additive of the present invention can affect the necessary conversion of the native halogen present in the fuel source into a desirable halogen compound that can affect the desired level of mercury oxidation. It should be noted that the higher the native halogen level in a fuel source the less there is a need, or even no need, for the injection of one or more additionally supplied halogen-containing compounds. Here, as well as elsewhere in the specification and claims, individual range values (even from different embodiments) can be combined to form additional and/or non-disclosed ranges.

To date, the dominant method for mercury oxidation is through the use of chemical additive such as bromine or iodine addition to the coal. For bituminous units with SCR it is possible to get high mercury oxidation up to 90 percent depending upon the activity of the SCR catalyst and ammonia slip. As the SCR activity goes down the only option is to add more additionally supplied halogen-containing compounds to the coal, combustion gas, or flue gas stream to achieve the desired level of mercury oxidation.

Two different datasets are presented from pilot testing at two different facilities to demonstrate the capability of one or more metal-bearing compounds or metal-bearing additives to improve Hg removal by efficient utilization of the native halogen in the coal. In Case 1 a Powder River Basin (PRB) coal was tested with; (i) 400 ppm chlorine added to the coal; and (ii) 400 ppm chlorine added to the coal in combination with the addition of 0.25 weight percent of a metal-bearing additive, based on the weight of the coal supplied and compared to a baseline with neither chlorine nor a combination of chlorine and metal-bearing additive is supplied. In this instance the metal-bearing additive is formed from Fe₂O₃ (hematite) with 0.2 weight percent copper oxide added to the iron. This pilot facility had a spray dryer absorber (SDA) present which removed oxidized mercury. The results for various mercury values for the baseline (no chlorine added and no combination of chlorine and metal-bearing additive added), the injection of just 400 ppm chloride, and the injection of the combination of 400 ppm chlorine and 0.25 weight percent, based on the weight of the coal supplied, of the metal-bearing additive are shown in Table 1.

TABLE 1

| | | Elemental | Oxidized | Percent |
|---|---|---|---|---|
| | Total Hg | Hg | Hg | oxidized |
| Test | at stack | at stack | at stack | Hg at stack |
| Baseline | 7 | 4.6 | 2.4 | 34.2 |
| Coal + 400 ppm | 4 | 1.5 | 2.5 | 62.5 |
| chloride | | | | |
| Coal + 400 ppm of | 2 | 0.3 | 1.7 | 85 |
| chloride + 0.25 weight | | | | |
| percent metal-bearing | | | | |
| additive | | | | |

As can be seen from the results in Table one the metal-bearing additive according to one embodiment of the present invention results in the reduction of all of the measured mercury values. Thus, the present invention results in a significant increase in the am amount of elemental mercury oxidized thereby permitting the present invention to allow for a higher amount of mercury capture in one or more downstream air quality control systems or devices.

In Case 2 Central Appalachian Coal (CAPP) was tested with only the addition of 0.25 weight percent of a metal-bearing additive, based on the weight of the coal supplied and compared to a baseline with no combination of chlorine and metal-bearing additive is supplied. In this instance the metal-bearing additive is formed from Fe₂O₃ (hematite) with 0.2 weight percent copper oxide added to the iron. The CAPP coal has a higher native chlorine content (approximately 750 ppm in coal) as a part of the coal composition itself and therefore there is no need to add any external or additionally supplied halogen. This pilot facility had a electrostatic precipitator (ESP) and a wet flue gas desulfurization (WFGD) present in the air quality control systems train.

TABLE 2

| | | Elemental | Oxidized | Percent |
|---|---|---|---|---|
| | Total Hg | Hg | Hg | oxidized |
| Test | at stack | at stack | at stack | Hg at stack |
| Baseline | 5 | 4 | 1 | 20 |
| Coal + 0.25 weight | 2.8 | 1.5 | 1.3 | 46.4 |
| percent metal-bearing | | | | |
| additive | | | | |

The data shows that with addition of only one type of metal-bearing additive according to an embodiment of the present invention to the coal there was significant improvement in mercury oxidation and hence overall mercury removal.

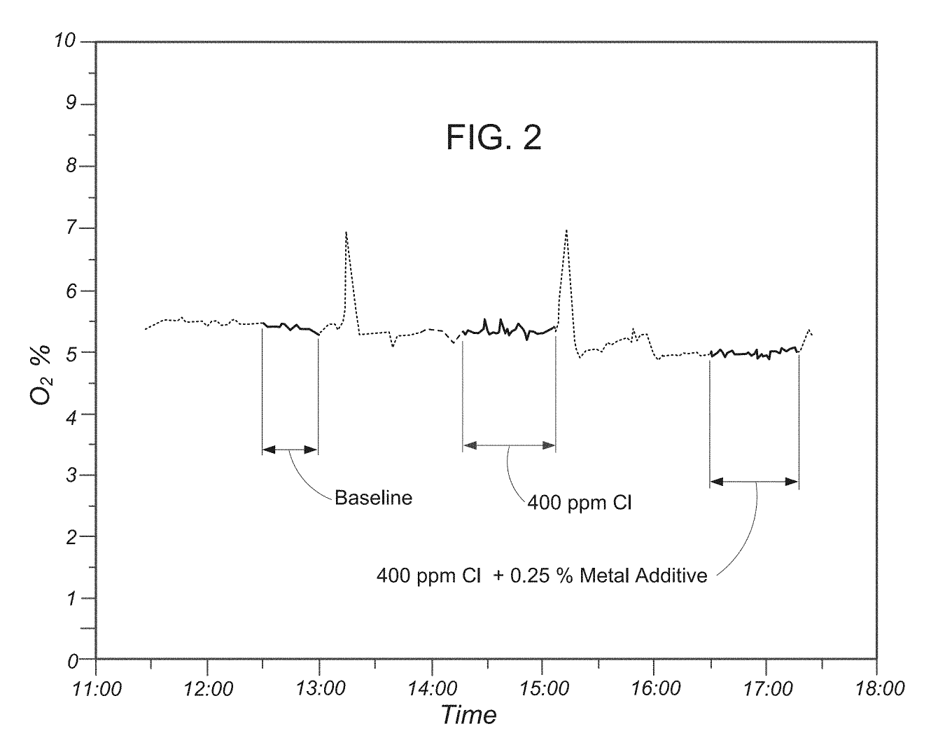

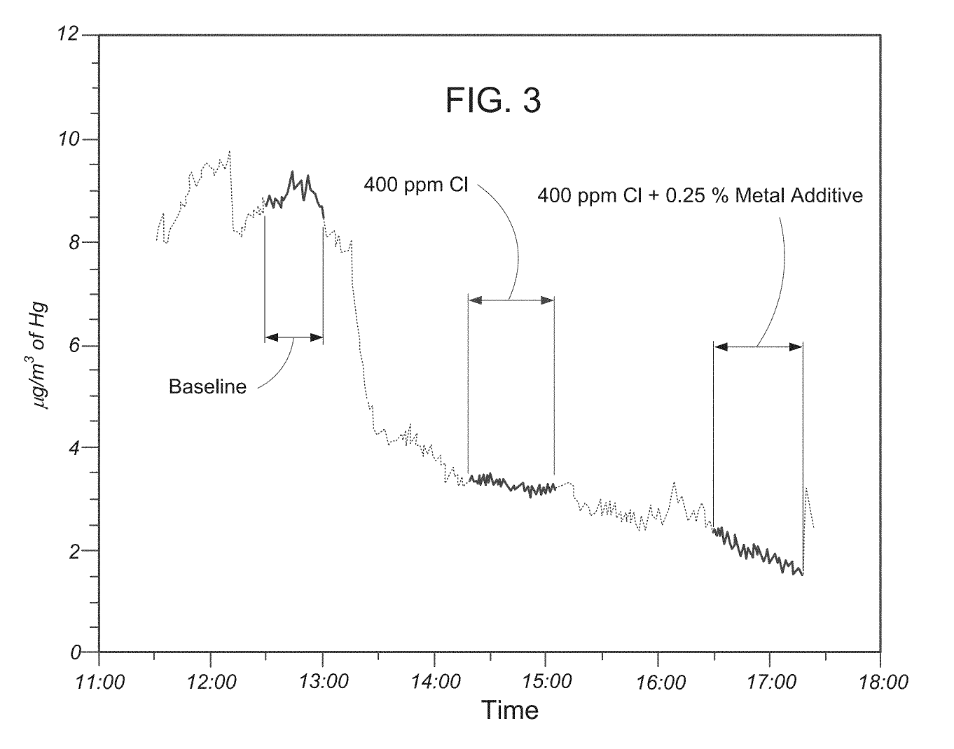

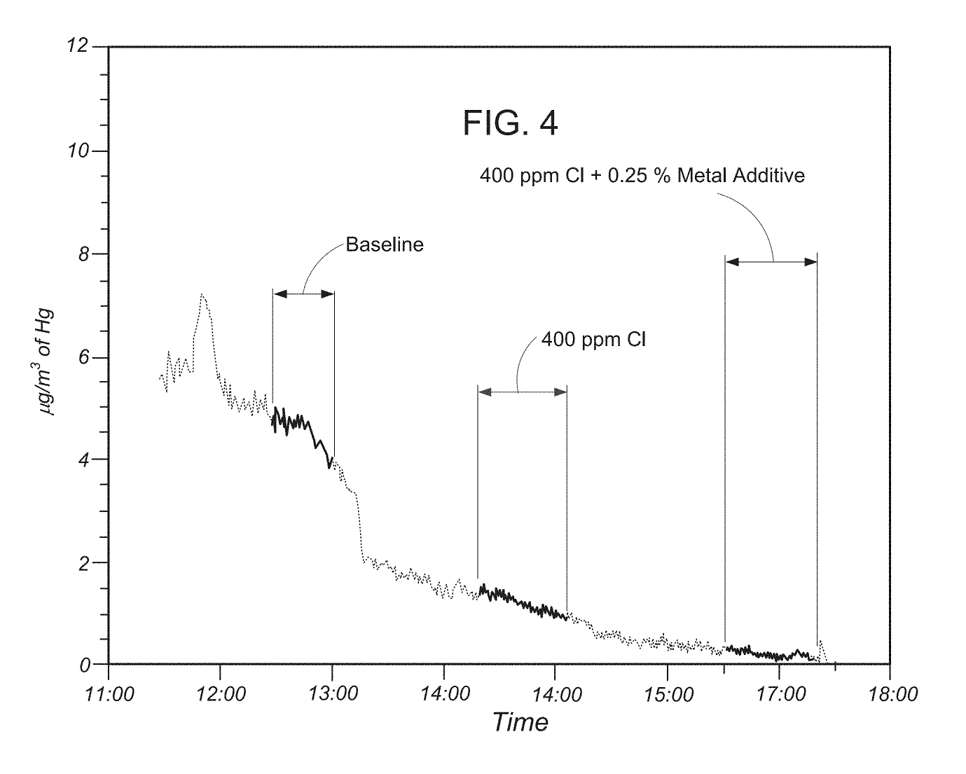

Turning to FIGS. 2 through 4, these graphs illustrate data collected showing: (a) in FIG. 2 a graph illustrating oxygen gas concentration during not only three different test conditions labeled “Baseline,” “400 ppm Cl” (i.e., 400 ppm chlorine) and “400 ppm Cl+0.25% Metal Additive” (i.e., 400 ppm chlorine plus 0.25 weight percent one or more metal-bearing compounds or metal-bearing additives based on the weight of the fuel being combusted) (as represented by the solid bolded labeled portions of the line in FIG. 2) but during the time before, between and after the three different test conditions (as represented by the dotted portions of the line in FIG. 2); (b) in FIG. 3 a graph illustrating total mercury (Hg) concentration during not only three different test conditions labeled “Baseline,” “400 ppm Cl” (i.e., 400 ppm chlorine) and “400 ppm Cl+0.25% Metal Additive” (i.e., 400 ppm chlorine plus 0.25 weight percent one or more metal-bearing compounds or metal-bearing additives based on the weight of the fuel being combusted) (as represented by the solid bolded labeled portions of the line in FIG. 3) but during the time before, between and after the three different test conditions (as represented by the dotted portions of the line in FIG. 3); and (c) in FIG. 4 a graph illustrating elemental mercury (Hg) concentration during not only three different test conditions labeled “Baseline,” “400 ppm Cl” (i.e., 400 ppm chlorine) and “400 ppm Cl+0.25% Metal Additive” (i.e., 400 ppm chlorine plus 0.25 weight percent one or more metal-bearing compounds or metal-bearing additives based on the weight of the fuel being combusted) (as represented by the solid bolded labeled portions of the line in FIG. 4) but during the time before, between and after the three different test conditions (as represented by the dotted portions of the line in FIG. 4).

Given the above, in one specific test, the test conditions of the labeled and bolded portions of each graph from left to right correspond to a baseline, an injection of 400 ppm chloride to the coal, and an injection of 400 ppm of chloride and 0.25 weight percent metal-bearing additive (based on the weight of the coal) to the coal. In this instance the metal-bearing additive is formed from Fe₂O₃ (hematite) with 0.2 weight percent copper oxide added to the iron. As can be seen from FIGS. 2 through 4, the injection of just 400 ppm chlorine to a PRB coal in order to simulate a coal with a sufficiently high native halogen level results in the reduction of the amount of total mercury and elemental mercury (see FIGS. 3 and 4) over the baseline conditions. Additionally, the injection of 400 ppm of chloride and 0.25 weight percent metal-bearing additive (based on the weight of the coal) to a PRB coal in order to simulate a coal with a sufficiently high native halogen level results in a further reduction of the amount of total mercury and elemental mercury (see FIGS. 3 and 4) over both the baseline conditions and the chlorine-only conditions.

When utilized herein the step of “providing one or more metal-bearing compounds to a combustion zone or flue gas stream of a furnace, or boiler, at a point that is both prior to entry of the flue gas into an SCR” encompasses not only supplying the one or more metal-bearing compounds and/or metal-bearing additives to a combustion zone or flue gas stream as discussed above but also encompasses supplying the one or more metal-bearing compounds and/or metal-bearing additives to a combustion zone or flue gas stream by adding the one or more metal-bearing compounds and/or metal-bearing additives to the combustible fuel source.

In one embodiment, the various embodiments of the present invention permit conversion of at least about 30 weight percent of any elemental mercury (Hg⁰) present in a combustion, or flue, gas stream into oxidized mercury (usually, but not limited to, Hg²⁺) regardless of whether or not any one or more halogen-containing compounds are provided to the combustion, or flue, gas stream. In another embodiment, the present invention permits conversion of at least about 35 weight percent, at least about 40 weight percent, at least about 45 weight percent, at least about 50 weight percent, at least about 55 weight percent, or even at least about 60 weight percent of any elemental mercury (Hg⁰) present in a combustion, or flue, gas stream into oxidized mercury (usually, but not limited to, Hg²⁺) regardless of whether or not any one or more halogen-containing compounds are provided to the combustion, or flue, gas stream. Here, as well as elsewhere in the specification and claims, individual range values (even from different embodiments) can be combined to form additional and/or non-disclosed ranges.

In one embodiment, the various embodiments of the present invention permit conversion of at least about 30 weight percent of any elemental mercury (Hg⁰) present in a combustion, or flue, gas stream into oxidized mercury (usually, but not limited to, Hg²⁺) without the use of any added halogen supplied in the form of any one or more halogen-containing compounds due to the presence of at least about 300 ppm native halogen in the fuel to be combusted. In another embodiment, the present invention permits conversion of at least about 35 weight percent, at least about 40 weight percent, at least about 45 weight percent, at least about 50 weight percent, at least about 55 weight percent, or even at least about 60 weight percent of any elemental mercury (Hg⁰) present in a combustion, or flue, gas stream into oxidized mercury (usually, but not limited to, Hg²⁺) without the use of any added halogen supplied in the form of any one or more halogen-containing compounds due to the presence of at least about 300 ppm, at least about 325 ppm, at least about 350 ppm, at least about 375 ppm, at least about 400 ppm, at least about 425 ppm, at least about 450 ppm, at least about 475 ppm, at least about 500 ppm, at least about 525 ppm, at least about 550 ppm, at least about 575 ppm, at least about 600 ppm, at least about 625 ppm, at least about 650 ppm, at least about 675 ppm, at least about 700 ppm, at least about 725 ppm, at least about 750 ppm, at least about 775 ppm, at least about 800 ppm, at least about 825 ppm, at least about 850 ppm, at least about 875 ppm, at least about 900 ppm, at least about 925 ppm, at least about 950 ppm, at least about 975 ppm, or even at least about 1000 ppm native halogen in the fuel to be combusted. Here, as well as elsewhere in the specification and claims, individual range values (even from different embodiments) can be combined to form additional and/or non-disclosed ranges.

While specific embodiments of the present invention have been shown and described in detail to illustrate the application and principles of the invention, it will be understood that it is not intended that the present invention be limited thereto and that the invention may be embodied otherwise without departing from such principles. In some embodiments of the invention, certain features of the invention may sometimes be used to advantage without a corresponding use of the other features. Accordingly, all such changes and embodiments properly fall within the scope of the following claims.

What is claimed is:

1. A method for reducing or eliminating the amount and/or concentration of one or more halogen-containing compounds used to achieve mercury capture in a flue gas, the method comprising the steps of:
(a) providing at least one combustible fuel source to a combustion zone of a furnace or boiler, the at least one combustible fuel having at least 400 ppm by weight of one or more native halogens and/or native halogen-containing compounds;
(b) providing one or more metal-bearing compounds to a combustion zone or flue gas stream of a furnace, or boiler, at a point that is both prior to entry of the flue gas into an SCR;
(c) providing less than about 2.5 ppm of one or more halogen-containing compounds to a combustion zone or flue gas stream of a furnace, or boiler, prior to entry of the flue gas into an SCR, wherein the halogen portion of the one or more halogen-containing compounds are liberated in the combustion zone or flue gas stream of the furnace or boiler and are converted to one or more corresponding gaseous hydrogen halide compounds;
(d) permitting the one or more metal-bearing compounds to catalyze the conversion of the corresponding one or more hydrogen halides formed from the injection of the one or more halogen-containing compounds and any one or more hydrogen halides formed from any one or more native halogen compounds and/or one or more native halogen-containing compounds to one or more corresponding elemental halogen compounds; and
(e) permitting the resulting one or more corresponding elemental halogen compounds to react with gaseous mercury present in the combustion zone or flue gas stream of the furnace, or boiler, thereby resulting in oxidation of the gaseous mercury so as to convert the gaseous mercury into one or more corresponding mercury halides.

2. The method of claim 1, wherein the metal-bearing compound is selected from at least one inorganic iron-bearing compound.

3. The method of any of claim 1 or 2, wherein the metal-bearing compound is selected from metallic iron, one or more iron oxides, iron carbonate, iron (II) acetate, iron (II) nitrate, iron (III) nitrate, iron (II) sulfate, iron (III) sulfate, or mixtures of two or more thereof.

4. The method of any of claim 1 or 2, wherein the metal-bearing compound is selected from iron (III) oxide, iron (II) carbonate, iron (II) oxide, iron (II) acetate, or mixtures of two or more thereof.

5. The method of any of claims 2 to 4, wherein the metal-bearing compound is selected further comprises at least one copper-bearing compound.

6. The method of claim 1, wherein the metal-bearing compound is selected from, or further comprises, at least one of metallic nickel, nickel acetate, nickel bromate, nickel bromide, nickel carbonate, basic nickel carbonate, nickel chloride, nickel fluoride, nickel hydroxide, nickel iodate, nickel iodide, nickel nitrate, nickel oxide, nickel sulfate, or mixtures of two or more thereof.

7. The method of claim 6, wherein the metal-bearing compound is selected from, or further comprises, at least one organic nickel-bearing compound.

8. The method of claim 1, wherein the metal-bearing compound is selected from, or further comprises, at least one of metallic copper, copper acetate, copper bromate, copper bromide, copper trioxybromide, copper carbonate, basic copper carbonate, copper chloride, copper fluoride, copper hydroxide, copper iodate, copper iodide, copper nitrate, copper oxide, copper sulfate, or mixtures of two or more thereof.

9. The method of claim 8, wherein the metal-bearing compound is selected from, or further comprises, at least one organic copper-bearing compound.

10. The method of claim 1, wherein the metal-bearing compound is selected from, or further comprises, at least one of metallic cobalt, cobalt acetate, cobalt bromate, cobalt bromide, cobalt carbonate, cobalt chloride, cobalt fluoride, cobalt hydroxide, cobalt iodate, cobalt iodide, cobalt nitrate, cobalt oxide, cobalt sulfate, or mixtures of two or more thereof.

11. The method of claim 10, wherein the metal-bearing compound is selected from, or further comprises, at least one organic cobalt-bearing compound.

12. The method of any of claims 1 to 11, wherein the metal-bearing compound is selected from, or further comprises, one or more iron-bearing compounds, one or more nickel-bearing compounds, one or more copper-bearing compounds, one or more cobalt-bearing compounds, or mixtures of any two or more thereof.

13. The method of any of claims 1 to 12, wherein the at least one metal-bearing compound is provided to the combustion zone via addition to pulverized coal.

14. The method of any of claims 1 to 13, wherein the at least one metal-bearing compound is provided to the combustion zone via a dedicated supply line.

15. The method of any of claims 1 to 14, wherein the one or more halogen-containing compounds are selected from one or more organic, or inorganic, bromine-containing compounds and/or chlorine-containing compounds.

16. The method of any of claims 1 to 15, wherein the halogen-containing compound is non-transition metal halide compound.

17. The method of claim 1, wherein the at least one metal-bearing compound is a combination of at least one iron-bearing compound and one or more copper-bearing compounds, one or more cobalt-bearing compounds and one or more nickel-bearing compounds where the total amount of the one or more copper-bearing compounds, one or more cobalt-bearing compounds and one or more nickel-bearing compounds is in the range of about 0.2 weight percent to about 0.5 weight percent, based on the total weight of all of the metal-bearing compounds.

18. A method for reducing or eliminating the amount and/or concentration of one or more halogen-containing compounds used to achieve mercury capture in a flue gas, the method comprising the steps of:
(A) providing at least one combustible fuel source to a combustion zone of a furnace or boiler, the at least one combustible fuel having at least 400 ppm by weight of one or more native halogens and/or native halogen-containing compounds;
(B) providing one or more metal-bearing compounds to a combustion zone or flue gas stream of a furnace, or boiler, at a point that is both prior to entry of the flue gas into an SCR;
(C) providing less than about 1 ppm of one or more halogen-containing compounds to a combustion zone or flue gas stream of a furnace, or boiler, prior to entry of the flue gas into an SCR, wherein the halogen portion of the one or more halogen-containing compounds are liberated in the combustion zone or flue gas stream of the furnace or boiler and are converted to one or more corresponding gaseous hydrogen halide compounds;
(D) permitting the one or more metal-bearing compounds to catalyze the conversion of the corresponding one or more hydrogen halides formed from the injection of the one or more halogen-containing compounds and any one or more hydrogen halides formed from any one or more native halogen compounds and/or one or more native halogen-containing compounds to one or more corresponding elemental halogen compounds; and
(E) permitting the resulting one or more corresponding elemental halogen compounds to react with gaseous mercury present in the combustion zone or flue gas stream of the furnace, or boiler, thereby resulting in oxidation of the gaseous mercury so as to convert the gaseous mercury into one or more corresponding mercury halides.

19. The method of claim 18, wherein the metal-bearing compound is selected from at least one inorganic iron-bearing compound.

20. The method of any of claim 18 or 19, wherein the metal-bearing compound is selected from metallic iron, one or more iron oxides, iron carbonate, iron (II) acetate, iron (II) nitrate, iron (III) nitrate, iron (II) sulfate, iron (III) sulfate, or mixtures of two or more thereof.

21. The method of any of claim 18 or 19, wherein the metal-bearing compound is selected from iron (III) oxide, iron (II) carbonate, iron (II) oxide, iron (II) acetate, or mixtures of two or more thereof.

22. The method of any of claims 19 to 21, wherein the metal-bearing compound is selected further comprises at least one copper-bearing compound.

23. The method of claim 18, wherein the metal-bearing compound is selected from, or further comprises, at least one of metallic nickel, nickel acetate, nickel bromate, nickel bromide, nickel carbonate, basic nickel carbonate, nickel chloride, nickel fluoride, nickel hydroxide, nickel iodate, nickel iodide, nickel nitrate, nickel oxide, nickel sulfate, or mixtures of two or more thereof.

24. The method of claim 23, wherein the metal-bearing compound is selected from, or further comprises, at least one organic nickel-bearing compound.

25. The method of claim 18, wherein the metal-bearing compound is selected from, or further comprises, at least one of metallic copper, copper acetate, copper bromate, copper bromide, copper trioxybromide, copper carbonate, basic copper carbonate, copper chloride, copper fluoride, copper hydroxide, copper iodate, copper iodide, copper nitrate, copper oxide, copper sulfate, or mixtures of two or more thereof.

26. The method of claim 25, wherein the metal-bearing compound is selected from, or further comprises, at least one organic copper-bearing compound.

27. The method of claim 18, wherein the metal-bearing compound is selected from, or further comprises, at least one of metallic cobalt, cobalt acetate, cobalt bromate, cobalt bromide, cobalt carbonate, cobalt chloride, cobalt fluoride, cobalt hydroxide, cobalt iodate, cobalt iodide, cobalt nitrate, cobalt oxide, cobalt sulfate, or mixtures of two or more thereof.

28. The method of claim 27, wherein the metal-bearing compound is selected from, or further comprises, at least one organic cobalt-bearing compound.

29. The method of any of claims 18 to 28, wherein the metal-bearing compound is selected from, or further comprises, one or more iron-bearing compounds, one or more nickel-bearing compounds, one or more copper-bearing compounds, one or more cobalt-bearing compounds, or mixtures of any two or more thereof.

30. The method of any of claims 18 to 29, wherein the at least one metal-bearing compound is provided to the combustion zone via addition to pulverized coal.

31. The method of any of claims 18 to 30, wherein the at least one metal-bearing compound is provided to the combustion zone via a dedicated supply line.

32. The method of any of claims 18 to 31, wherein the one or more halogen-containing compounds are selected from one or more organic, or inorganic, bromine-containing compounds and/or chlorine-containing compounds.

33. The method of any of claims 18 to 32, wherein the halogen-containing compound is non-transition metal halide compound.

34. The method of claim 18, wherein the at least one metal-bearing compound is a combination of at least one iron-bearing compound and one or more copper-bearing compounds, one or more cobalt-bearing compounds and one or more nickel-bearing compounds where the total amount of the one or more copper-bearing compounds, one or more cobalt-bearing compounds and one or more nickel-bearing compounds is in the range of about 0.2 weight percent to about 0.5 weight percent, based on the total weight of all of the metal-bearing compounds.

35. A method for reducing or eliminating the amount and/or concentration of one or more halogen-containing compounds used to achieve mercury capture in a flue gas, the method comprising the steps of:
(I) providing at least one combustible fuel source to a combustion zone of a furnace or boiler, the at least one combustible fuel having at least 400 ppm by weight of one or more native halogens and/or native halogen-containing compounds;
(II) providing one or more metal-bearing compounds to a combustion zone or flue gas stream of a furnace, or boiler, at a point that is both prior to entry of the flue gas into an SCR;
(III) providing no additional halogen-containing compounds other than those natively contained in the at least one combustible fuel to a combustion zone or flue gas stream of a furnace, or boiler, prior to entry of the flue gas into an SCR, wherein the halogen portion of the one or more native halogen-containing compounds are liberated in the combustion zone or flue gas stream of the furnace or boiler and are converted to one or more corresponding gaseous hydrogen halide compounds;
(IV) permitting the one or more metal-bearing compounds to catalyze the conversion of the corresponding one or more natively supplied hydrogen halides formed from the injection of the one or more halogen-containing compounds; and
(V) permitting the resulting one or more corresponding elemental halogen compounds to react with gaseous mercury present in the combustion zone or flue gas stream of the furnace, or boiler, thereby resulting in oxidation of the gaseous mercury so as to convert the gaseous mercury into one or more corresponding mercury halides.

36. The method of claim 35, wherein the metal-bearing compound is selected from at least one inorganic iron-bearing compound.

37. The method of any of claim 35 or 36, wherein the metal-bearing compound is selected from metallic iron, one or more iron oxides, iron carbonate, iron (II) acetate, iron (II) nitrate, iron (III) nitrate, iron (II) sulfate, iron (III) sulfate, or mixtures of two or more thereof.

38. The method of any of claim 35 or 36, wherein the metal-bearing compound is selected from iron (III) oxide, iron (II) carbonate, iron (II) oxide, iron (II) acetate, or mixtures of two or more thereof.

39. The method of any of claims 36 to 38, wherein the metal-bearing compound is selected further comprises at least one copper-bearing compound.

40. The method of claim 35, wherein the metal-bearing compound is selected from, or further comprises, at least one of metallic nickel, nickel acetate, nickel bromate, nickel bromide, nickel carbonate, basic nickel carbonate, nickel chloride, nickel fluoride, nickel hydroxide, nickel iodate, nickel iodide, nickel nitrate, nickel oxide, nickel sulfate, or mixtures of two or more thereof.

41. The method of claim 40, wherein the metal-bearing compound is selected from, or further comprises, at least one organic nickel-bearing compound.

42. The method of claim 35, wherein the metal-bearing compound is selected from, or further comprises, at least one of metallic copper, copper acetate, copper bromate, copper bromide, copper trioxybromide, copper carbonate, basic copper carbonate, copper chloride, copper fluoride, copper hydroxide, copper iodate, copper iodide, copper nitrate, copper oxide, copper sulfate, or mixtures of two or more thereof.

43. The method of claim 42, wherein the metal-bearing compound is selected from, or further comprises, at least one organic copper-bearing compound.

44. The method of claim 35, wherein the metal-bearing compound is selected from, or further comprises, at least one of metallic cobalt, cobalt acetate, cobalt bromate, cobalt bromide, cobalt carbonate, cobalt chloride, cobalt fluoride, cobalt hydroxide, cobalt iodate, cobalt iodide, cobalt nitrate, cobalt oxide, cobalt sulfate, or mixtures of two or more thereof.

45. The method of claim 44, wherein the metal-bearing compound is selected from, or further comprises, at least one organic cobalt-bearing compound.

46. The method of any of claims 35 to 45, wherein the metal-bearing compound is selected from, or further comprises, one or more iron-bearing compounds, one or more nickel-bearing compounds, one or more copper-bearing compounds, one or more cobalt-bearing compounds, or mixtures of any two or more thereof.

47. The method of any of claims 35 to 46, wherein the at least one metal-bearing compound is provided to the combustion zone via addition to pulverized coal.

48. The method of any of claims 35 to 47, wherein the at least one metal-bearing compound is provided to the combustion zone via a dedicated supply line.

49. The method of any of claims 35 to 48, wherein the at least one combustible fuel has at least 500 ppm by weight of one or more native halogens and/or native halogen-containing compounds.

50. The method of any of claims 35 to 48, wherein the at least one combustible fuel has at least 600 ppm by weight of one or more native halogens and/or native halogen-containing compounds.

51. The method of any of claims 35 to 48, wherein the at least one combustible fuel has at least 700 ppm by weight of one or more native halogens and/or native halogen-containing compounds.

52. The method of any of claims 35 to 48, wherein the at least one combustible fuel has at least 750 ppm by weight of one or more native halogens and/or native halogen-containing compounds.

53. The method of claim 35, wherein the at least one metal-bearing compound is a combination of at least one iron-bearing compound and one or more copper-bearing compounds, one or more cobalt-bearing compounds and one or more nickel-bearing compounds where the total amount of the one or more copper-bearing compounds, one or more cobalt-bearing compounds and one or more nickel-bearing compounds is in the range of about 0.2 weight percent to about 0.5 weight percent, based on the total weight of all of the metal-bearing compounds.

54. The method of claim 35, wherein at least about 30 weight percent to at least about 60 weight percent of any gaseous elemental mercury present in the combustion zone or flue gas stream of the furnace, or boiler, is oxidized into one or more forms of ionized mercury.
